(19) United States
(12) Patent Application Publication
(10) Pub. No.: US 2024/0404818 A1
(43) Pub. Date: Dec. 5, 2024

(54) SYSTEMS AND METHODS FOR ACOUSTIC MANIPULATION AND SAMPLING OF LIPIDS AND LIPID PARTICLES

(71) Applicant: UNIVERSITY OF SOUTH FLORIDA, Tampa, FL (US)

(72) Inventors: Theresa Evans-Nguyen, Tampa, FL (US); Venkat Rama Bhethanabotla, Tampa, FL (US); Ashton Taylor, Tampa, FL (US); Yuqi Huang, Tampa, FL (US); Cheyenne Sircher, Tampa, FL (US)

(21) Appl. No.: 18/732,406

(22) Filed: Jun. 3, 2024

Related U.S. Application Data
(60) Provisional application No. 63/505,628, filed on Jun. 1, 2023.

(51) Int. Cl. H01J 49/16; B06B 1/06; H01J 49/04

(52) U.S. Cl. CPC H01J 49/168; B06B 1/0622; H01J 49/0459; B06B 2201/77

(57) ABSTRACT

Disclosed herein is a method of preparing macromolecular structures for analysis, including placing a macromolecular sample on a surface acoustic wave (SAW) device including: a piezoelectric surface, a first transducer in contact with the piezoelectric surface, a second transducer in contact with the piezoelectric surface, and a sample region disposed between the first transducer and the second transducer and configured to receive the macromolecular sample, the sample region configured to remain electrically isolated from each of the first transducer and the second transducer; applying disruption electrical energy, having a disruption frequency and a disruption power, to each of the first transducer and the second transducer to transform the macromolecular sample into a disrupted macromolecular sample; and applying nebulization electrical energy, comprising a nebulization frequency and a nebulization power, to each of the first transducer and the second transducer, to transform the disrupted macromolecular sample into a nebulized macromolecular sample.

### CROSS-REFERENCE TO RELATED APPLICATIONS

The present application is based on and claims priority from U.S. patent application Ser. No. 63/505,628, filed on Jun. 1, 2023, the entire disclosure of which is incorporated herein by reference.

### STATEMENT REGARDING FEDERALLY SPONSORED RESEARCH

This invention was made with government support under grant number 2108795 awarded by the National Science Foundation. The government has certain rights in the invention.

### BACKGROUND

Naturally occurring and engineered macromolecular structures, such as extracellular vesicles and liposomes, present a unique analytical challenge due to their size, diverse composition, and tendency to aggregate. For example, the mass spectrometry analysis of polar and nonpolar lipids can involve different optimal extraction and separation methods and even ionization sources. While organic solvents and detergents are commonly employed to chemically disrupt these lipid nanostructures, such conditions may be inherently denaturing to vesicle cargo, including proteins, thereby reducing analytical accuracy. Furthermore, significant nonpolar lipid composition, such as cholesterol, hinders conventional electrospray ionization (ESI) that varies with the solvent environment. Several factors, including lipids' polarity, acyl chain length, and degree of saturation, affect critical micelle concentration, which likely affects aggregation that subsequently induces matrix effects in ESI

Therefore, there is a need for systems and methods of preparing macromolecular structures for analysis which may overcome the aforementioned limitations of chemical disruption and subsequent ionization.

### SUMMARY OF THE INVENTION

Disclosed herein is a method of preparing macromolecular structures for analysis, including: placing a macromolecular sample on a surface acoustic wave (SAW) device including: a piezoelectric surface, a first transducer in contact with the piezoelectric surface, a second transducer in contact with the piezoelectric surface, and a sample region disposed between the first transducer and the second transducer and configured to receive the macromolecular sample, the sample region configured to remain electrically isolated from each of the first transducer and the second transducer; applying disruption electrical energy, comprising a disruption frequency and a disruption power, to each of the first transducer and the second transducer to transform the macromolecular sample into a disrupted macromolecular sample; and applying nebulization electrical energy, comprising a nebulization frequency and a nebulization power, to each of the first transducer and the second transducer, to transform the disrupted macromolecular sample into a nebulized macromolecular sample.

Further disclosed herein is a method of preparing macromolecular structures for analysis, including: providing a first surface acoustic wave (SAW) device including: a first piezoelectric surface, a first pair of transducers in contact with the first piezoelectric surface, and a first sample region disposed between the first pair of transducers, the first sample region configured to remain electrically isolated from each of the first pair of transducers; placing a macromolecular sample on the first SAW device; applying disruption electrical energy, comprising a disruption frequency and a disruption power, to each of the first pair of transducers to transform the macromolecular sample into a disrupted macromolecular sample; and providing a second SAW device including: a second piezoelectric surface, a second pair of transducers in contact with the second piezoelectric surface, a second sample region disposed between the second pair of transducers, the second sample region configured to remain electrically isolated from each of the second pair of transducers; and applying nebulization electrical energy, comprising a nebulization frequency and a nebulization power, to each of the second pair of transducers to transform the disrupted macromolecular sample into a nebulized macromolecular sample.

In another aspect, disclosed herein is a system for analyzing macromolecular structures, including: a surface acoustic wave (SAW) device comprising: a piezoelectric surface a first transducer in contact with the piezoelectric surface, a second transducer in contact with the piezoelectric surface, and a sample region configured to receive a macromolecular structure sample between, and electrically isolated from, each of the first transducer and the second transducer; and a controller configured to apply electrical energy, having a frequency and a power, to the first transducer and second transducer.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A-1C are schematic diagrams showing various aspects of a two-chip design in accordance with the disclosure herein. FIG. 1A shows samples placed on a first chip for SAW disruption, then transferred to a second chip for SAW nebulization and ionization. FIG. 1B depicts an example of a representative embodiment of a chip used for SAW disruption. FIG. 1C shows possible parameter choices for the two-chip design.

FIGS. 2A-2B are schematic diagrams showing aspects of another embodiment of the disclosure. FIG. 2A is a schematic diagram of a SAW device configuration, which may work with a CD and MS device and may use a continuous mode of SAWN-APCI. FIG. 2B is an image of set up for continuous mode of SAWN-APCI according to an example embodiment hereof.

FIGS. 3A-3B depict aspects of a process according to an embodiment of the disclosure. In FIG. 3A, a conceptual flow chart is shown, illustrating a process according to an embodiment of the disclosure. In FIG. 3B, an aspect of a process is depicted for preparation of “free” internal standard calibrators and internal standard spiked into DOPC liposome solutions with ammonium acetate prior to being exposed to 64 MHz for 40 and 60 seconds.

FIGS. 4A-4B are graphs showing performance of two approaches. The graphs depict results from evaluation of prototypical lipids from lipid vesicles in organic solutions using (FIG. 4A) SAWN-APCI and (FIG. 4B) ESI, comprising a spectrum of 50 m DOPC and 12.5 m cholesterol in 10 mM ammonium acetate/methanol/chloroform at 4:1 at 25 μL/min.

FIG. 5 is a graph showing representative raw data of mass spectrum analysis, including 0 second and 60 second duration disruptions. For 0 second SAW disruption, using SAWN-APCI alone on liposomes results in significant noise.

FIG. 6 is a graph of ion intensity versus disruption time. Liposomes of ˜100 nm diameter (127 μM DOPC) in water were subjected to varying frequencies and durations of SAW disruption parameters.

FIG. 7 is a set of images obtained from representative thermal imaging of SAW disruption. Top row: 16 MHz; Bottom row: 32 MHz. From left to right, images are captured at 0, 20, and 40 seconds, respectively.

FIG. 8 is a graph of DOPC liposome concentration, showing DOPC liposomes ranging in concentrations from 1.56 to 25 μM, and the DOPC liposomes' ion intensity after being exposed to 64 MHz for 40 s.

FIG. 9 is a set of plots showing liposomes—1.25 μM to 25 μM in 10 mM ammonium acetate water after being exposed to disruption by 64 MHz SAW for 60 seconds and followed by off-line SAWN-APCI.

FIG. 10 is a graph showing two DOPC lipid calibration curves from 5 to 60 μm, using each 50 μm DOPE and 25 μM DPPC as an IS.

FIGS. 11A-111B are graphs depicting characteristics relating to experiments performed using embodiments hereof. Using SAWN-APCI alone, signals were collected for multiple discrete 1-uL droplets for each of the calibrator solutions of DOPC and DOPE internal standard. FIG. 11A is a graph showing results of mass spectrum analysis of 20 μM DOPC with 50 L DOPE (IS) from drop at 0.92 minutes. The area of DOPC (786 m/z), oxygen adduct (802 m/z), sodium adduct (808 m/z), PC head group (184 m/z) and its dimer (1572 m/z) and DOPE (744 m/z) and dimer (1487 m/z) were taken from FIG. 11B their extracted ion chromatograms.

FIGS. 12A-12B are graphs depicting characteristics relating to experiments performed using embodiments hereof. The experiments involved mass spectrum analysis of DOPC with 50 μM DPPC internal standard in both DOPC free lipid form (FIG. 12A) and liposome form (FIG. 12B). DPPC as an internal standard suffers complications from the PC headgroup. The origin of this peak is indistinguishable from DOPC or DPPC. While the ionization efficiencies are similar between both lipids while in their free lipid form, DPPC diminishes when analyzed with DOPC in its liposome form, a similar phenomenon seen when using DOPE as an internal standard.

FIG. 13: is a graph showing that liposomes comprised 10% of cholesterol at 15 μM when total lipid were spiked with 50 μM DOPE IS, and exposed to 60 s of 64 MHz SAW disruption.

FIG. 14 is a plot showing results from an analysis in which liposomes composed of 15 μM total lipid were analyzed with varying cholesterol content: 0, 2.5, 10, and 40% cholesterol, each spiked with 50 μM DOPE IS.

FIG. 15 shows a graph of mass spectra data of DOPC-cholesterol liposomes following disruption. Cholesterol signal is inconsistently observed and/or released from the liposome.

FIGS. 16A-16B are a pair of graphs of results per embodiments hereof. FIG. 16A shows mass spectrum analysis results of solutions combining the DOPC lipid with cytochrome C subjected to SAWN-APCI alone. FIG. 16B shows mass spectrum analysis results of DOPC liposome with free cytochrome C present, after being subjected to both SAW disruption and SAWN-APCI.

FIG. 17 is a graph showing that SAWN transfers a small charge to nebulized droplets which allows for viewing of these lipid species on the MS without a CD needle. There is a four-fold increase in signal with CD. Nonpolar cholesterol is visible in most SAWN-CD spectra.

FIGS. 18A-18B are a plot and diagram showing use of an embodiment hereof, relating to DOPC liposomes spiked with DPPC from different sizes. FIG. 18A is a plot showing size of liposome vs A_{[DOPC]}/A_{[DPPC]} after disruption for 40 seconds and 60 seconds using a 64 MHz SAW chip. FIG. 18B depicts an illustrative overview of lysing steps corresponding to FIG. 18A.

FIGS. 19A-19B shows the lipodomic profiles of exosomes collected adipose tissue. FIG. 19A shows the peak area for each lipid group. FIG. 19B shows the molecular structure for the top 5 peaks in FIG. WWA.

FIG. 20. Representative single chip SAW design.

FIG. 21. SAWN single chip device schematic.

FIG. 22. SAWN single chip device fabrication process.

FIG. 23. SAWN Mask: detailed schematic of a single chip design.

FIGS. 24A-24C are a set of graphs showing results of experiments performed relating to MHz instant nebulization. FIG. 24A shows mass spectrum relating to 0.16-22 min of the chromatogram, drop 2. FIG. 24B shows total ion chromatogram. FIG. 24C shows mass spectrum relating to 1.55-1.59 min of the chromatogram, drop 2.

FIG. 25. Mass spectrum of DPPC liposomes; 40 MHz, instant nebulization.

FIG. 26. Mass spectrum of DPPC liposomes after 40 seconds of 40 MHz SAWs; 40 seconds lysing to nebulization.

FIG. 27. Overview of nebulized samples to stainless steel wafer.

FIGS. 28A-28D. Scanning electron microscopy images of samples nebulized directly on wafer; 40 MHz chips, sputtered with Au/PA. FIG. 28A. DPPC liposomes on a stainless-steel wafer, before being fixed. FIG. 28B. DPPC liposomes nebulized directly onto a stainless-steel wafer. FIGS. 28C and 28D. DPPC liposomes lysed for 40 seconds at 40 MHz before being nebulized onto a stainless-steel wafer.

FIG. 29. Representative block diagram of a method of preparing macromolecular structures for analysis in accordance with some disclosed embodiments.

FIG. 30. Representative block diagram of a method of preparing macromolecular structures for analysis in accordance with some disclosed embodiments.

FIGS. 31A-31B. Example stages schematics are shown for stages designed for 30 to 60 MHz (FIG. 31A) and 10 and 20 MHz (FIG. 31B).

FIG. 32. shows a workflow using a first SAW device, filtering of the disrupted macromolecular sample, and a second SAW device to prepare extracellular vesicles (EVs) for mass spectrometry analysis.

FIG. 33. A mass spectrum from 3 nebulized 1-μL droplets containing disrupted extracellular vesicles prepared as described in Example 4.

### DETAILED DESCRIPTION

Disclosed herein are systems and methods for preparing macromolecular structures for analysis. The systems and method disclosed herein overcome the analytical challenges presented by macromolecular structures, including their size, diverse composition, and tendency to aggregate. In one embodiment, the methods and systems disclosed herein prepare macromolecular samples for analysis by mass spectrometry. The systems and methods disclosed herein offer a mechanical alternative to chemical lysis of macromolecular structures, enabling analysis of low-volume, aqueous samples while preserving native, biologically relevant conditions.

In a first aspect, disclosed herein is a system for preparing and analyzing macromolecular structures, including a surface acoustic wave (SAW) device including: a piezoelectric surface; a first transducer in contact with the piezoelectric surface, a second transducer in contact with the piezoelectric surface, and a sample region configured to receive a macromolecular structure sample between, and electrically isolated from, each of the first transducer and the second transducer, and a controller configured to apply electrical energy, having a frequency and a power, to the first transducer and second transducer. The systems disclosed herein may further include a second surface acoustic wave (SAW) device including a second piezoelectric surface, a primary transducer in contact with the second piezoelectric surface, an auxiliary transducer in contact with the second piezoelectric surface, and a second sample region configured to receive a macromolecular structure sample between, and electrically isolated from, each of the primary transducer and the auxiliary transducer. The controller is configured to apply a second electrical energy, having a second frequency and a second power, to the primary transducer and auxiliary transducer. In this embodiment, the power and the second power are different powers.

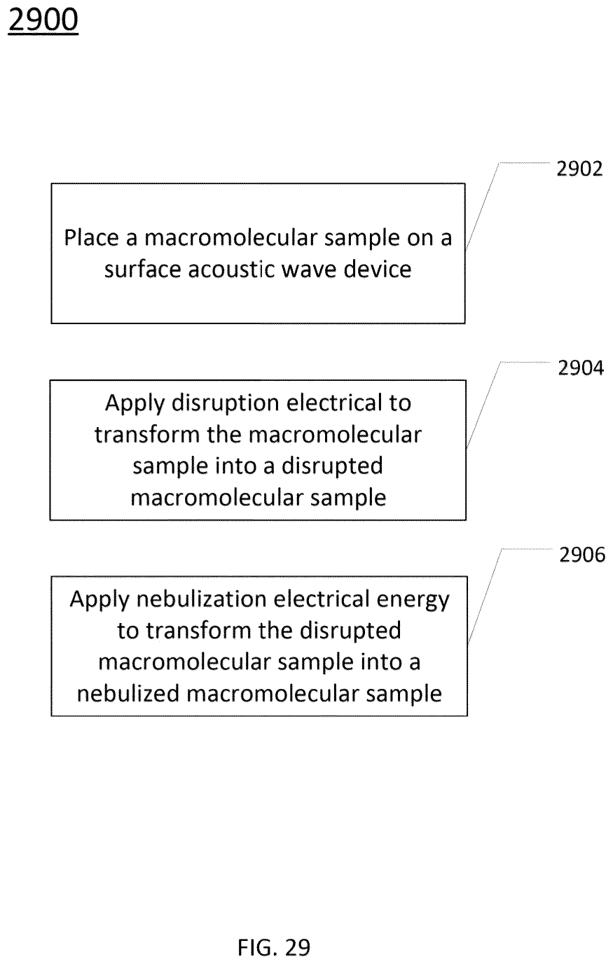

In a second aspect, disclosed herein is a method for preparing macromolecular structures for analysis (see FIG. 29), including the step of placing a macromolecular sample on a surface acoustic wave (SAW) device (2902). As disclosed herein, a SAW device includes a piezoelectric surface, a first transducer in contact with the piezoelectric surface, a second transducer in contact with the piezoelectric surface, and a sample region disposed between the first transducer and the second transducer and configured to receive the macromolecular sample. The sample region is configured to remain electrically isolated from each of the first transducer and the second transducer. The method further includes a two-stage manipulation of the macromolecular sample: i) disruption and ii) nebulization. The first stage is accomplished by applying disruption electrical energy, having a disruption frequency and a disruption power, to each of the first transducer and the second transducer to transform the macromolecular sample into a disrupted macromolecular sample (2904). The second stage is accomplished by applying nebulization electrical energy, having a nebulization frequency and a nebulization power, to each of the first transducer and the second transducer, to transform the disrupted macromolecular sample into a nebulized macromolecular sample (2906).

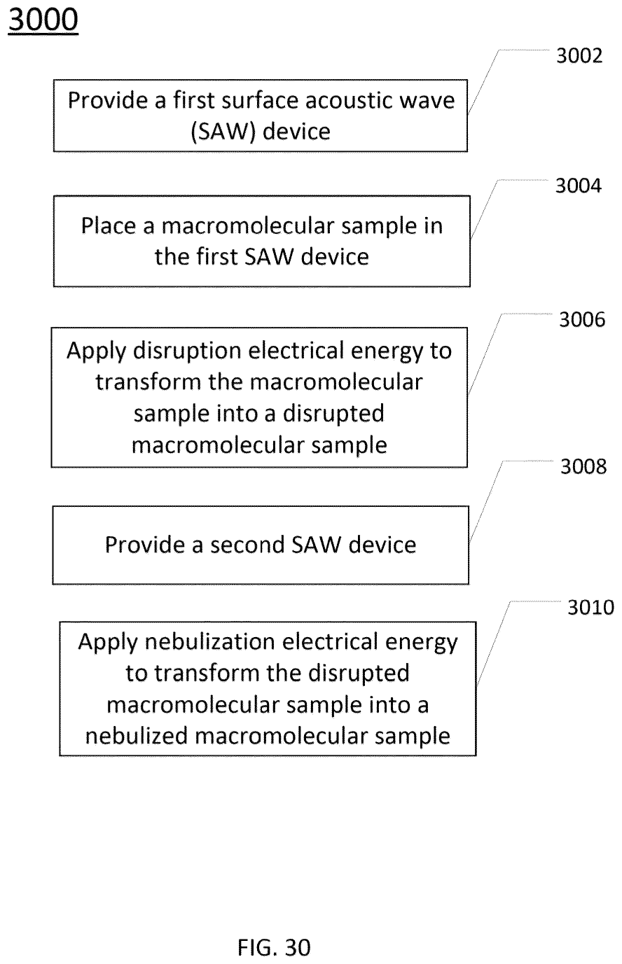

In some cases, the disclosed method is performed using one SAW device. In other cases, the disclosed method is performed using two or more SAW devices (see FIG. 30) including the steps of providing a first surface acoustic wave (SAW) device including a first piezoelectric surface, a first pair of transducers in contact with the first piezoelectric surface, and a first sample region disposed between the first pair of transducers (3002). The first sample region is configured to remain electrically isolated from each of the first pair of transducers. The method further includes placing a macromolecular sample on the first SAW device (3004) and applying disruption electrical energy, comprising a disruption frequency and a disruption power, to each of the first pair of transducers to transform the macromolecular sample into a disrupted macromolecular sample (3006). Further, the method includes providing a second SAW device including: a second piezoelectric surface, a second pair of transducers in contact with the second piezoelectric surface, and a second sample region disposed between the second pair of transducers (3008). The second sample region is configured to remain electrically isolated from each of the second pair of transducers. The method includes applying nebulization electrical energy, comprising a nebulization frequency and a nebulization power, to each of the second pair of transducers to transform the disrupted macromolecular sample into a nebulized macromolecular sample (3010). In some cases, the first SAW device is different than the second SAW device. In some cases, the difference between the first SAW device and the second SAW device may be the disruption power, disruption frequency, nebulization power, nebulization frequency, or any combinations thereof. In other cases, the first SAW device is substantially equivalent to the second SAW device.

In another aspect, it may be desirable to operate a single SAW device at a substantially equivalent frequency for macromolecular sample disruption and nebulization (i.e., the disruption frequency is substantially equivalent to the nebulization frequency). However, nebulization of the macromolecular sample can entail higher powers than powers used for disruption. For example, the disruption power may be between about 0.2 W and about 1.5 W while the nebulization power may be between about 4.0 W and about 15 W. SAW device heating while operating under high nebulization powers is a significant problem and can result in SAW device failure. Accordingly, methods and systems to enable the use of both disruption power and nebulization power on a single SAW device, operated at substantially equivalent disruption and nebulization frequencies, without device failure are desirable. It was determined that pulsing the nebulization electrical energy allowed heat to dissipate and thereby prevented SAW device failure. In comparison to a continuous waveform, pulsing the nebulization electrical energy causes the disrupted macromolecular sample to experience a fraction of an otherwise equivalent continuous waveform. In some cases, the nebulization electrical energy can be provided in a periodic, cycling, or pulsed manner, such as a pulsed sine waveform. In some cases, the pulsed sine waveform has a duty cycle of 20% to 80% and a pulse period of 100 μs. In some cases, the systems disclosed herein further include the SAW device in thermal contact with a cooling apparatus. Several cooling apparatuses are known in the art, including air cooling, evaporative cooling, thermoelectric cooling, vapor-compression refrigeration, or vapor-adsorption refrigeration. In some cases, the cooling apparatus is a Peltier cooler. In some cases, the lithium niobate piezoelectric surface is in thermal contact with a Peltier cooler.

The disruption electrical energy is applied for a disruption duration. The disruption duration may range from no less than 10 second to no greater than 90 seconds, no less than 5 seconds to no greater than 100 seconds, no less than 0.5 seconds to no greater than 120 seconds, no less than 10 seconds to no greater than 60 seconds, no less than 5 seconds to no greater than 90 seconds. The nebulization electrical energy is applied for a nebulization duration. The nebulization duration may range from no less than 0.5 second to no greater than 10 seconds. In some cases, may range from no less than 0.25 seconds to no greater than 15 seconds, no less than 1 second to no greater than 60 seconds, no less than 0.5 seconds to no greater than 30 seconds, or no less than 0.01 seconds to no greater than 5 seconds. In some cases when the nebulization electrical energy is pulsed, the nebulization duration may range from no less than 0.5 second to no greater than 10 seconds, no less than 1 second to no greater than 60 seconds, no less than 0.5 seconds to no greater than 30 seconds, or no less than 0.01 seconds to no greater than 5 seconds.

In another aspect of the systems and methods disclosed herein, the macromolecular sample may be delivered to or placed on the sample region in a discrete droplet. In some cases, the droplet volume may range from about 0.10 μL to about 100 μL, about 0.25 μL to about 50.0 μL, about 0.30 μL to about 25.0 μL, about 0.4 μL to about 15.0 μL, about 0.50 μL to about 10.0 μL, about 0.50 μL to about 7.00 μL, or about 0.25 μL to about 1.50 μL. In other cases, the macromolecular sample may be delivered to or placed on the sample region in a continuous flow. The flow rate of the macromolecular sample may range from about 0.10 μL/min to about 100 μL/min, about 0.25 μL/min to about 50.0 μL/min, about 0.30 μL/min to about 25.0 μL/min, about 0.4 μL/min to about 15.0 μL/min, about 0.50 μL/min to about 10.0 μL/min, about 0.50 μL/min to about 7.00 μL/min, or about 0.25 μL/min to about 1.50 μL/min. Delivering the macromolecular sample to the sample region can be accomplished using known methods in the art, such as transporting by gravity (i.e., pouring, tilting the sample region), pipette, capillary tube, or microfluidics.

In methods and systems where the first SAW device is different than the second SAW device, a disrupted macromolecular sample may be transported from the first SAW device to the second SAW device. The disrupted macromolecular sample may be transported using known methods in the art, such as transporting by gravity (i.e., pouring, tilting the sample region), pipette, capillary tube, or microfluidics. In some cases, the disrupted macromolecular sample may undergo a processing step before being placed on the second SAW device. For example, the disrupted macromolecular sample may be filtered, concentrated, purified, enriched, extracted, diluted, exchanged liquid (e.g., exchanged buffers), or any combinations thereof in advance of being placed on the second SAW device. In one example, the disrupted macromolecular sample may include disrupted extracellular vesicles. The disrupted extracellular vesicles may undergo protein filtration. In some cases, the filtrate (i.e., the permeate) may be transferred to the second SAW device to undergo nebulization to produce a nebulized macromolecular sample. In other cases, the retentate may be transferred to the second SAW device to undergo nebulization to produce a nebulized macromolecular sample.

In another aspect, the systems and methods disclosed herein prepare macromolecular samples for analysis by mass spectrometry. Accordingly, the methods disclosed herein further include ionizing the nebulized macromolecular sample and analyzing the ionized macromolecular sample with a mass spectrometer. The systems disclosed herein further include an ionization source configured to ionize at least a portion of the nebulized macromolecular sample to produce an ionized macromolecular sample. In some cases, the systems disclosed herein further include a mass spectrometer having an inlet configured to receive at least a portion of the ionized macromolecular sample.

There are several suitable ionization techniques already established in the art, including electron impact ionization, fast atom bombardment, electrospray ionization, matrix assisted laser desorption ionization, and atmospheric pressure chemical ionization. In some cases, ionization may be accomplished with a corona discharge device to produce an ionized macromolecular sample, as described in the Examples below. Methods and systems for sampling into an atmospheric pressure inlet mass spectrometer are described in U.S. Patent Application Publication 2024/0096610 A1 and U.S. Pat. No. 8,415,619B2, which are each incorporated, in their entirety, by reference herein. Some systems and methods further include high-field asymmetric waveform ion mobility spectrometry (FAIMS) configured to receive the ionized macromolecular sample. FAIMS is an atmospheric pressure ion mobility technique which separates gas-phase ions by their behavior in strong and weak electric fields in order to achieve online fractionation (e.g., filtering out chemical noise).

Another aspect, the systems disclosed herein include a controller configured to apply electrical energy, having a frequency and a power, to the first transducer and second transducer. In some embodiments, the controller is further configured to apply a second electrical energy, having a second frequency and a second power, to the primary transducer and auxiliary transducer. In some cases, the power and the second power are different powers. In some cases, the electrical energy is a disruption electrical energy, and the second electrical energy is a nebulization electrical energy. Various controllers already documented in the art are suitable for use in the systems disclosed herein. A controller may include a computer, a power supply, a radio frequency generator, a radio frequency amplifier, instructions to execute the methods disclosed herein, and any combinations thereof. In some cases, the controller may further control an ionization source and/or a mass spectrometer. In some cases, the controller may coordinate the timing of applying the electrical energy and/or second electrical energy with the ionization source to produce an ionized macromolecular structure. In some cases, the controller may coordinate the timing of producing an ionized macromolecular structure with the inlet of a mass spectrometer receiving at least a portion of the ionized macromolecular sample.

### Definitions

As used herein, the term “macromolecular structure” refers to a material made of two or more basic molecular units. In some cases, a macromolecular structure may include proteins (e.g., polymers of amino acids), nucleic acids (e.g., polymers of nucleotides), carbohydrates (e.g., polymers of sugars) and lipids (with a variety of modular constituents). In some cases, the macromolecular structure may include one or more protein-protein complexes, vesicles (e.g., lipid vesicles such as liposomes), multilamellar vesicles, multivesicular vesicles, a double-bilayer vesicle, unilamellar vesicles, exosomes, extracellular vesicles, lipid bilayer—protein complexes (e.g., membrane proteins, membranous discs), cells, parts of cells, and any combinations thereof. In some cases, the macromolecular structure includes aggregates of one or more the above macromolecular structures, and any combinations thereof.

As used herein, the term “macromolecular sample” refers to a composition comprising at least one macromolecular structure and at least one liquid. The liquid may be a polar solvent, a nonpolar solvent, or any combinations thereof. In some cases, the liquid is water.

As used herein, the term “surface acoustic wave (SAW) device” or “SAW device” refers to a device configured to generate surface acoustic waves.

As used herein, the term “piezoelectric surface” refers to a surface containing at least one material capable of transforming an electrical signal (e.g., an electrical wave) to a mechanical wave (e.g., vibrations). The piezoelectric surface may include lithium niobate, lithium tantalate, aluminum nitrate, zinc oxide, quartz, polyvinylidene fluoride, lead zirconate titanate, barium titanate, potassium sodium tartrate, lead magnesium niobate, or any combinations thereof. In some cases, an optimum piezoelectric crystal cut may be selected as the piezoelectric surface. For example, the 128° YX cut of lithium niobate may be selected.

As used herein, the term “transducer” refers to a device that can convert energy from one form to another. In some cases, as disclosed herein, a transducer may include one or more electrodes, one or more arrays, one or more antennas, and any combinations thereof. In some cases, pairs of transducers may be used, such as an input transducer and an output transducer (e.g., a first transducer and a second transducer, a primary transducer and an auxiliary transducer) to form a first pair of transducers. In some cases, the transducer consists of a first transducer and a second transducer. In some cases, the transducer may be an interdigital transducer (IDT) having two interlocking comb-shaped arrays of metallic electrodes to form a periodic structure. In some cases, the transducer consists of a first IDT and a second IDT. In some cases, the transducer may include reflectors to direct, amplify, constructively interfere, or destructively interfere a radio frequency applied to the transducers. Reflectors may include one or more electrically disconnected metallic traces parallel to and distal to the interlocking comb-shaped arrays of metallic electrodes. The geometry and dimensions of the transducer may be optimized for producing surface acoustic waves. In particular, the transducers may be optimized for producing Rayleigh waves along the piezoelectric surface. The transducers may be characterized by IDT resonant frequencies, wavelengths, IDTs and reflectors apertures (Ia/Ra), delay line length (DL), reflectors numbers (R #) and IDT finger pair numbers (I #) given in Table 2. In some cases, the first transducer and second transducer have a wavelength from 410 μm to 60 μm, from 500 μm to 1 μm, or from 450 μm to 50 μm. In some cases, the first transducer and second transducer have an aperture from 9.0 mm to 10 mm, from 8.0 mm to 12 mm, or from 8.5 mm to 10.5 mm. In some cases, the transducers may be completely or partially coated in one or more electrically insulating resins or polymers.

As used herein, the term “sample region” refers to an area of the surface acoustic wave device which is configured to receive the macromolecular sample. The sample region may be located so that the sample will be exposed to surface acoustic waves produced by applying a radio frequency to one or more transducers in contact with a piezoelectric surface. For example, the sample region may be located on a top surface of the piezoelectric surface, between a first transducer and a second transducer. In some cases, the sample region is positioned in the delay line length (DL) between the first transducer and the second transducer. In some cases, the sample region is substantially on the same plane as the transducers on the piezoelectric surface. The sample region is electrically isolated from the one or more transducers. The sample region may be defined by a curved surface, such as a dimple or well. In some cases, the sample region is substantially or partially free of one or more electrically insulating resins or polymers. In some cases, the sample region may undergo a surface treatment, such as a surface functionalization, to improve the interaction of the macromolecular sample with the sample region. In some cases, the surface treatment may increase or decrease the contact angle of the macromolecular sample on the sample region. The surface treatment may include exposing the sample region to an oxygen plasma.

As used herein, the term “disrupt” or “disrupted” or “disruption” refers to breaking intermolecular forces within the macromolecular structure to produce a conformational change. In some cases, disrupting the macromolecular structure includes releasing individual components of the macromolecular structure into the at least one liquid in the macromolecular sample. In some cases, ‘disrupt’ refers to disaggregating aggregates of two or more macromolecular structures.

As used herein, the term “disruption electrical energy” refers to a radio frequency which is configured to produce a disrupted macromolecular sample. The disruption electrical energy can be characterized by a disruption frequency and a disruption power. The disruption frequency may be between about 10 MHz and about 100 MHz, between about 1 MHz and about 500 MHz, between about 15 MHz and about 99 MHz, between about 1 MHz and about 500 MHz, or between about 30 MHz and about 99 MHz. In some cases, the disruption frequency may be substantially equivalent to the nebulization frequency. In other cases, the disruption frequency may be different than the nebulization frequency. The disruption power may be between about 0.2 W and about 1.5 W, between about 0.3 W and about 1.5 W, between about 0.5 W and about 1.25 W, between about 0.1 W and about 3.0 W, or between about 0.2 W and about 1.1 W. In some cases, the disruption electrical energy is applied continuously or in pulses.

As used herein, the term “disruption duration” refers to the duration of time that the disruption electrical energy is applied to the macromolecular sample.

As used herein, the term “disrupted macromolecular sample” refers to a macromolecular structure that has undergone a conformational change due to broken intermolecular forces. The disrupted macromolecular sample includes the disrupted macromolecular structure and at least one liquid.

As used herein, the term “nebulization electrical energy” refers to a radio frequency which is configured to produce a nebulized macromolecular sample. The nebulization electrical energy can be characterized by a nebulization frequency and a nebulization power. The nebulization frequency may be between about 10 MHz and about 100 MHz, between about 1 MHz and about 500 MHz, between about 15 MHz and about 99 MHz, between about 1 MHz and about 500 MHz, or between about 30 MHz and about 99 MHz. The nebulization power may be between about 4.0 W and about 15 W, between about 2.0 W and about 20 W, between about 3.5 W and about 10 W, between about 4 W and about 20 W, or between about 3.5 W and about 15 W. In some cases, the nebulization electrical energy is applied continuously or in pulses. In cases where the nebulization electrical energy is pulsed, the average nebulization power, calculated as the peak power multiplied by the duty cycle, may range from about 4 W to about 15 W.

As used herein, the term “nebulize” or “nebulized” or “nebulization” refers to converting at least one liquid, and analytes contained therein, into a fine spray (e.g., an aerosol).

As used herein, the term “nebulized macromolecular sample” refers to converting at least one liquid, and a macromolecular structure contained therein, into a fine spray (e.g., an aerosol). In some cases, the macromolecular sample undergoes disruption in advance of nebulization such that the at least one liquid and a disrupted macromolecular structure contained therein, is converted into a fine spray (e.g., an aerosol).

Thus, while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

### Miscellaneous

Unless otherwise specified or indicated by context, the terms “a” “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

### Example 1—Two Chip Approach

### Overview

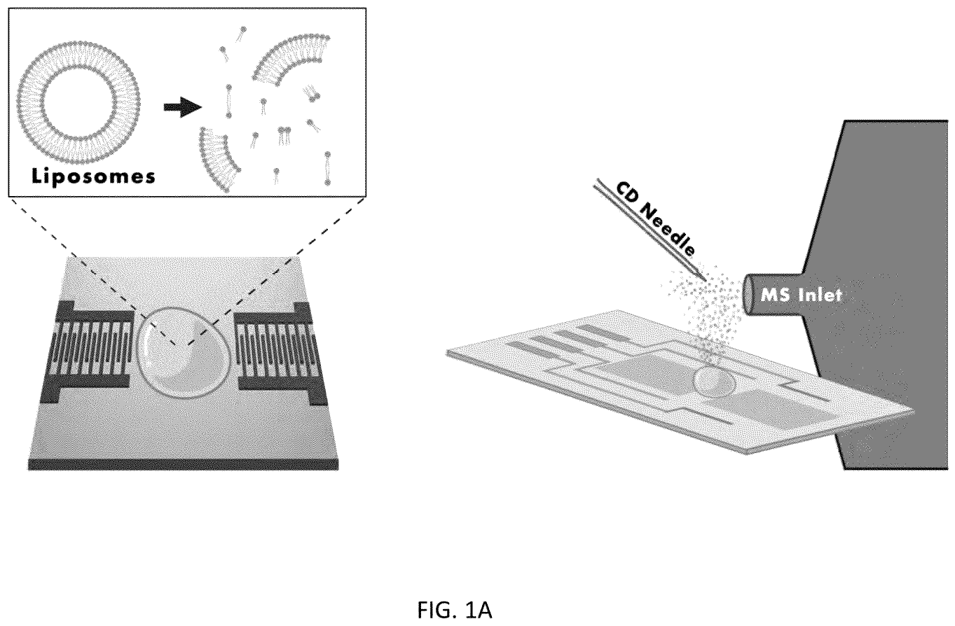

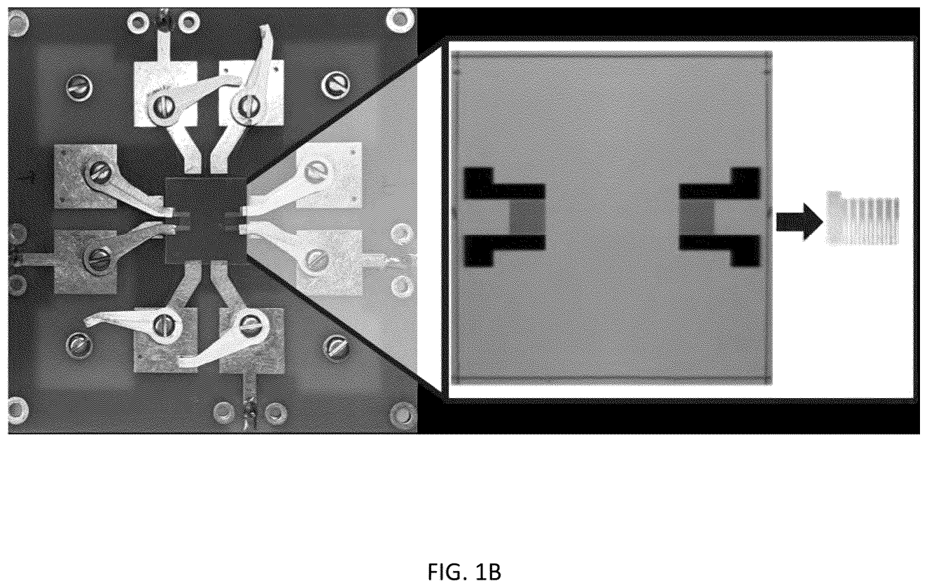

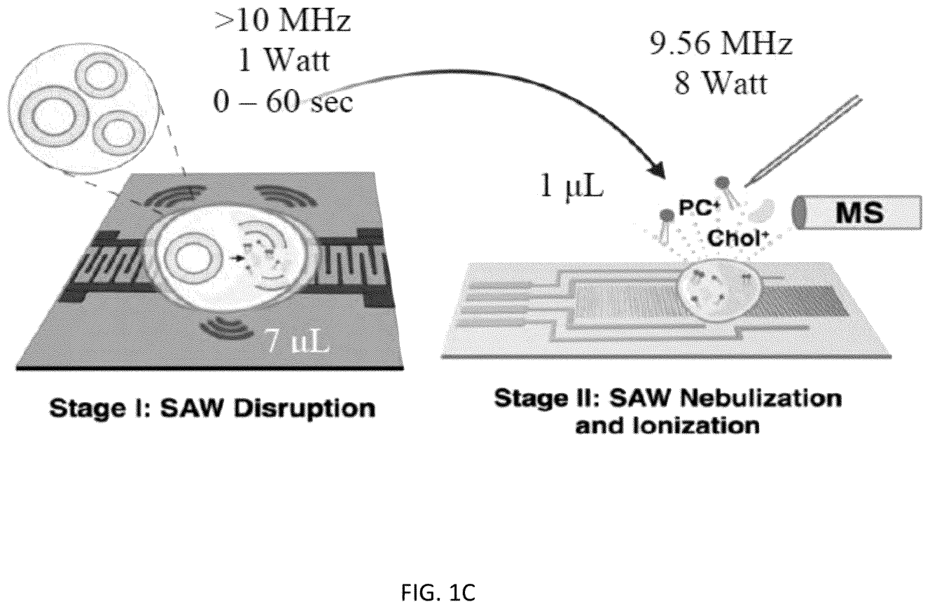

In Example 1, a two chip approach is used. A sample is placed on the first chip, which is used for SAW disruption, or a lysing step. The sample is then transferred to the second chip, which is used for SAW nebulization and ionization (see FIG. 1A). A CD needle (“corona discharge needle”) can be used, and the sample can be provided to a MS inlet from the second chip. FIG. 1B shows an example of what the first chip (e.g., the chip used for SAW disruption). FIG. 1C shows possible settings of the two chips, and possible chemical compositions of the samples.

### INTRODUCTION

Lipid vesicles are molecular constructs that appear widely in the biomedical field. For instance, synthetic lipid nanoparticles known as liposomes are commonly used as drug-delivery vehicles (1). Meanwhile, naturally occurring extracellular vesicles (EVs) are of increasing interest as disease biomarkers (2). Compositional analysis of lipid vesicles is unfortunately complex, with a diversity of lipids. Polar and nonpolar lipids can have different optimal extraction and separation methods and even ionization sources for mass spectrometric analysis (3). Liposome's customizability in composition and cargo allows for the ability to mimic EVs. Previous work by Frick et al. shows liposomes are capable of carrying membrane proteins, which makes liposomes ideal candidates as models for exosomes (4,5). While organic solvents and detergents commonly help to disrupt these lipid nanostructures, such conditions may be inherently denaturing to vesicle cargo, including proteins (6). Furthermore, significant nonpolar lipid composition, such as cholesterol, hinders conventional electrospray ionization (ESI) that varies with the solvent environment. Several factors, including lipids' polarity, acyl chain length, and degree of saturation, affect critical micelle concentration, which likely affects aggregation that subsequently induces matrix effects in ESI (7,8). Therefore, a means of mechanical handling may permit the maintenance of an aqueous chemical environment amenable to sampling both liposomal lipids and proteins.

In previous work, Song et al. reported on a broadband atmospheric pressure chemical ionization source that leveraged acoustic nebulization and corona discharge to sample both polar and nonpolar analytes (9,10). Additionally, Bhethanabotla and co-workers previously discerned the use of surface acoustic waves (SAWs) to disrupt nonspecific binding of proteins (11,12). Therefore, the application of SAWs could demonstrate potential utility in both lipid vesicle disruption and lipid ionization. Already in the literature, Taller et al. described the microscale use of SAWs to lyse EVs and characterized the process by changes in particle size distribution (13). Currently, in a more bottom-up approach, we employed SAWs to similarly disrupt lipid vesicles and instead characterize the process by their molecular composition in mass spectrometry.

Liposomes of a uniform size distribution served as model lipid vesicles with a single lipid bilayer (14). Simple liposome compositions consist of primarily dioleoylglycerophosphocholine (DOPC) with a fraction of cholesterol. Liposomes are also studied in mixtures with a protein and a lipid standard, added externally in a non-vesicle form. To distinguish two discrete functions, SAWs are applied in two modalities: one to disrupt the liposome macrostructure and a second to nebulize solution components for subsequent corona discharge ionization. We first validate that the commercial surface acoustic wave nebulization (SAWN), enhanced with corona discharge (CD), achieves satisfactory detection of polar and nonpolar lipids simultaneously. Following this demonstration, we investigate custom-built high-frequency (>10 MHz) SAW devices to establish operational parameters that achieve liposome disruption. We finally show the simultaneous detection of protein and liposome-derived phospholipids in a primarily aqueous solution. In this manner, the systematic use of acoustics exhibits the potential to aid mass spectral analysis in native applications of both lipids and proteins.

### Methods

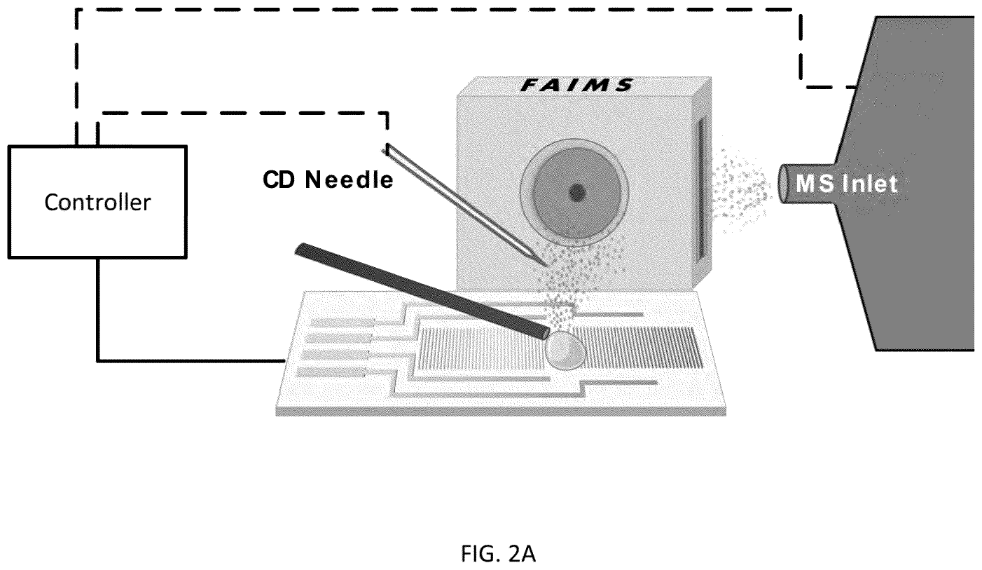

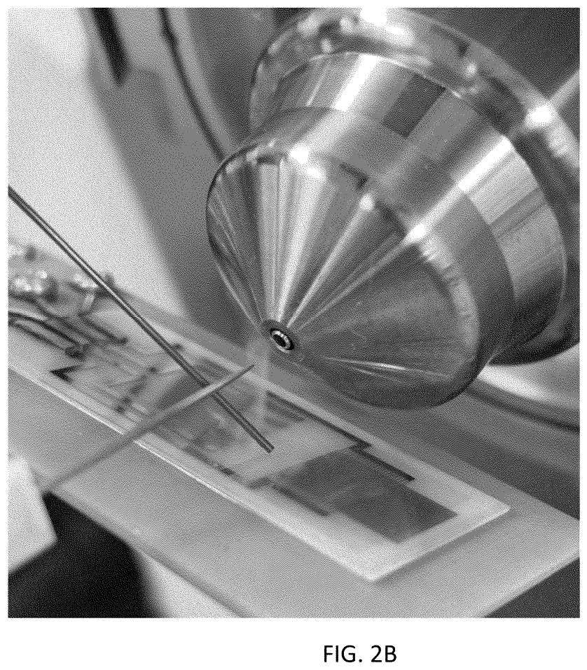

Ionization Methods. The SAWN setup, including the power supply (SAWN controller 2.0) and 9.56 MHz standing wave chips, was purchased from Deurion LLC (Seattle, WA). In droplet-mode, samples of typically 1 μL were placed in the center of the chip and rapidly nebulized at 8.25 W. To enhance ionization efficiency, a corona discharge source was assembled from the standard commercial atmospheric pressure chemical ionization (APCI) needle connected to an external high voltage power supply (PS350, Stanford Research System, Sunnyvale, CA). The APCI needle was placed in series with a 6 kΩ current limited resistor and a 60 μH inductor. The voltage supplied to the needle was set to +3.4 kV and current-limited to 1 μA. The SAWN chip was positioned 5 mm below the ion transfer tube of the MS whereas the APCI needle was positioned 7 mm away. For continuous-mode SAWN-APCI, depicted in FIGS. 2A-2B, a sample solution was supplied at a flow rate of 25 μL/min through PEEK tubing oriented above the center of the SAWN chip. Likewise for ESI, sample solution was supplied with a flow rate of 25 μL/min, through a 75 μm emitter at +3.4 kV.

SAWs Used for Disruption. For liposome solutions, the commercial Deurion SAWN device of 9.56 MHz was adapted to include a period of disruption using a lower applied power of ˜1 W followed by the nebulization step conducted at the higher power of 8.25 W. Additional SAW devices for liposome disruption were fabricated on a 4 in. 128° YX lithium niobate substrate. The two regions of interdigitated transducers (IDTs) on the SAW devices are designed with periodicities of 240, 120, 60, and 40 μm, in order to generate center frequencies at approximately 16.3 32.7, 65.3, and 98 MHz. The IDT regions were fabricated using standard photolithography. First, NR9 1500PY (Futurrex) negative photoresist was spin-coated on cleaned LiNbO₃ wafer to achieve a thickness of 2 μm. Then after UV light exposure using a Karl Suss mask aligner and baking, the pattern was developed and followed by 10 nm/100 nm Cr/Au metal layers using e-beam evaporation. Remaining metal was removed using an acetone bath, and the wafer was subsequently diced into 2 cm×2 cm chips.

For custom-fabricated SAW devices to achieve liposome disruption, an input signal at the center frequency was generated with an RF signal generator (Rohde & Schwarz SMA100A) and coupled with an RF amplifier (Mini-Circuits LZY-22+). The RF signal between the two IDTs results in Rayleigh wave formation along the piezoelectric surface. Propagation of these waves into the liquid sample droplet achieves acoustic streaming. All custom chips were operated at 1 W. Discrete 7 μL droplets of liposome solution were exposed to the low-power disruption mode for 10-60 s prior to MS analysis by SAWN-APCI.

Chemicals. LC/MS grade water and methanol were purchased from Fisher Scientific (Fair Lawn, NJ). Lipids in both solution and solid form, including 1,2-dioleoyl-sn-glycero-3-phosphocholine (DOPC), 1,2-dioleoyl-sn-glycero-3-phosphocholine (DOPE), 1,2-dipalmitoyl-sn-glycero-3-phosphocholine (DPPC), and cholesterol, were acquired from Avanti Polar Lipids (Birmingham, AL). Cytochrome C (Fischer Scientific) was prepared in water with 10 mM ammonium acetate (Millipore Sigma).

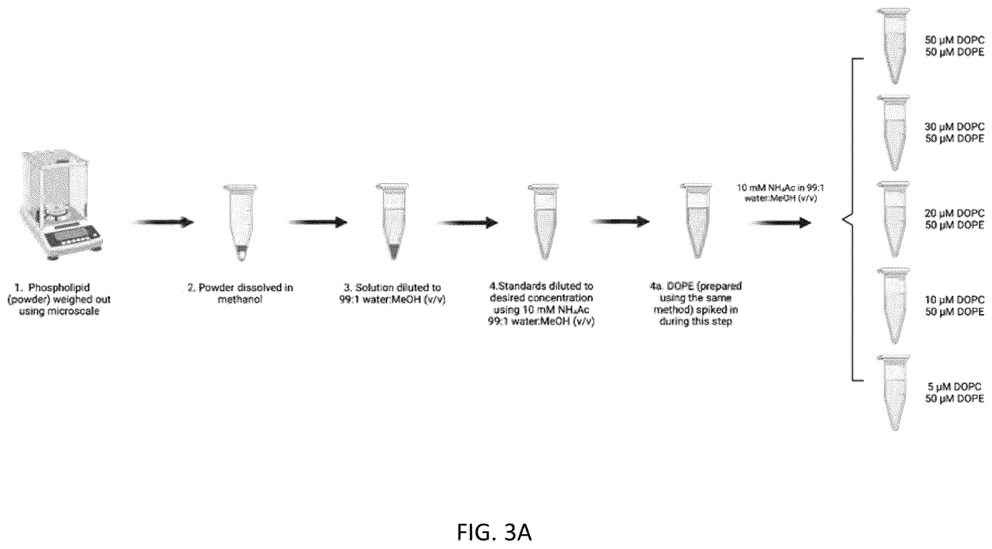

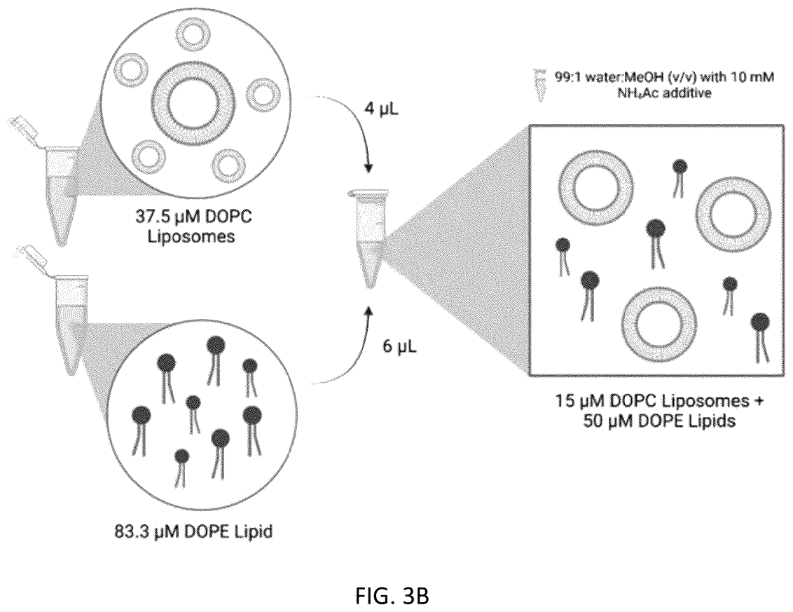

Liposome Preparation. DOPC-only liposomes were synthesized in-house using established methods of thin-film hydration and extrusion. 15,16 DOPC-cholesterol liposomes, ˜100 nm in size, were synthesized in a similar fashion to contain 2.5, 10, and 40 mol % cholesterol. Briefly, solutions of 1 mg/mL DOPC in chloroform are evaporated in a 25 mL round-bottom flask under vacuum using a Buchi Rotavapor R-200. After drying to a lipid film, water was added to hydrate and maintain the desired concentration. The suspension was agitated on the rotary evaporator for 2 h and then bath sonicated until translucent to form multilamellar vesicles. Vesicles were downsized over 11 passes through an extruder (Avanti Polar Lipids) with 100 nm polycarbonate membranes (Whatman) to produce ˜100 nm unilamellar liposomes. Following dilution and filtration, dynamic light scattering (Zetasizer Nano from Malvern Instruments and NanoBrook from Brookhaven Instruments) was used to measure the average hydrodynamic radius of the liposomes from ˜130 μL sample volumes. Particle size averages, obtained at 25° C., were found to be ˜95-115 nm for all liposomes. Subsequent liposome stock solution at 1 mg/mL was diluted to concentrations 1.56-127 μM in LC/MS grade water for SAW interrogations. All liposome solutions are reported in terms of formal lipid concentrations for clarity. Liposome solutions are spiked with internal standards (DOPE, DPPC) or cytochrome C, prepared in 1:99 (v/v) methanol/water with 10 mM ammonium acetate and vortexed prior to disruption (FIGS. 3A-3B).

Internal Standard Calibrator Formulation. Calibrator solutions of DOPC and DOPE lipids were formulated as formal concentrations in 1:99 methanol/water solutions to mimic the ultimately aqueous environment of the liposomes (FIGS. 3A-3B). The calibrator concentrations were chosen to be 5-60 μM DOPC and 50 μM DOPE. The working concentrations were chosen taking into account reported critical micelle concentration (CMC) of each lipid. Reported CMC values for similar class lipids in water are considerably low, in the nanomolar range. 17 Based on the trends for longer acyl chain length in water and the kinetics of phospholipids spontaneously aggregating at high concentrations, these particular lipids are most likely aggregated under these conditions. 18-21 We also adopted more “native” aqueous solution conditions by incorporating ammonium acetate to facilitate the dissolution of the lipids and ultimately ionization. Explicit preparation steps for these solutions are included in FIGS. 3A-3B.

Mass Spectrometer. MS analysis was performed on a linear ion trap mass spectrometer (LTQ XL, ThermoScientific, San Jose CA) in positive ion mode. The maximum in-source fragmentation of 100 V was used for additional desolvation and increased signal detection. Acquisition parameters of a 200 ms maximum inject time and three microscans were set. The onboard syringe pump used in direct infusion mode provided all continuous mode sampling.

### Results

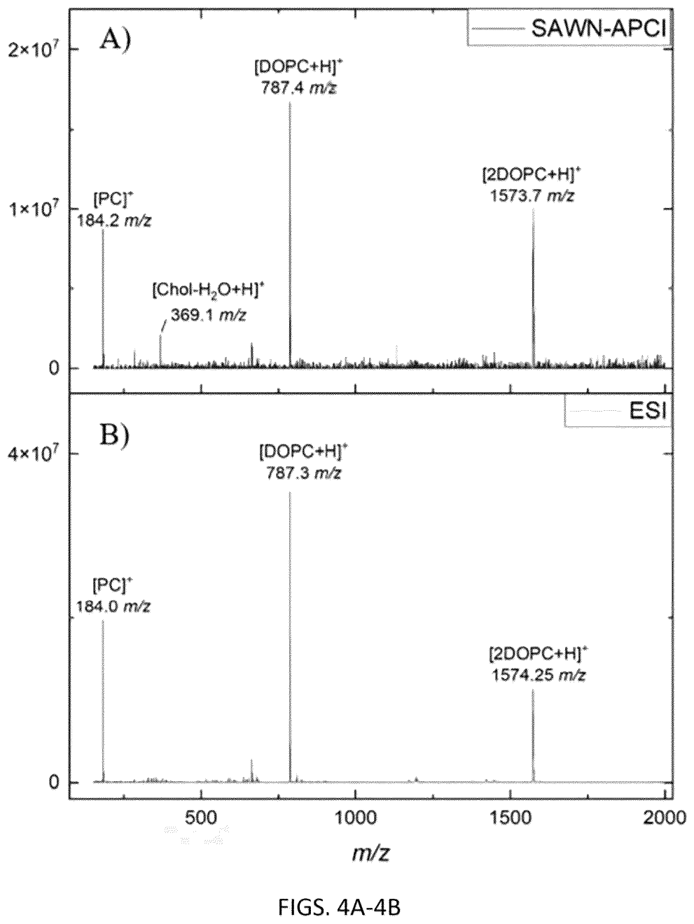

Demonstrated Application of SAWN-APCI to Lipids. We first established that baseline detection could be achieved with SAWN-APCI of specific polar and nonpolar membrane lipids in solution, as done for other targets in prior work. Prototypical membrane lipids, DOPC and cholesterol, were analyzed together as an organic solution using a continuous microflow mode for direct comparison of SAWN-APCI to ESI. In FIGS. 4A-4B, mass spectra depict clear DOPC ionization for both SAWN-APCI (FIG. 4A) and ESI (FIG. 4B) with comparable signal intensity, though greater noise is seen in SAWN-APCI. DOPC is represented by the protonated monomer [DOPC+H]+, the protonated dimer [2DOPC+H]+, and the phosphocholine headgroup [PC]+, a commonly observed fragment. 22 While cholesterol exhibits poor ionization efficiency by ESI, it is visibly represented in the SAWN-APCI spectrum as the molecular ion, but more prominently in the form of a water loss [Chol-H2O+H]+at 369.1 m/z. 23 The relative intensity of cholesterol, when normalized to total DOPC signal, was ˜5% and ˜1% for SAWN-APCI and ESI, respectively. We suspect that in addition to the physical volatilization of analyte species, the applied acoustic forces break up microscopic lipid aggregates to achieve better ionization efficiency. Anecdotally, the narrow-bore ESI emitter capillary clogged repeatedly, requiring frequent disassembly and cleaning of both the emitter and the ion inlet. Thus, the continuous microflow SAWN-APCI may be relatively more practical than ESI in the study of lipids.

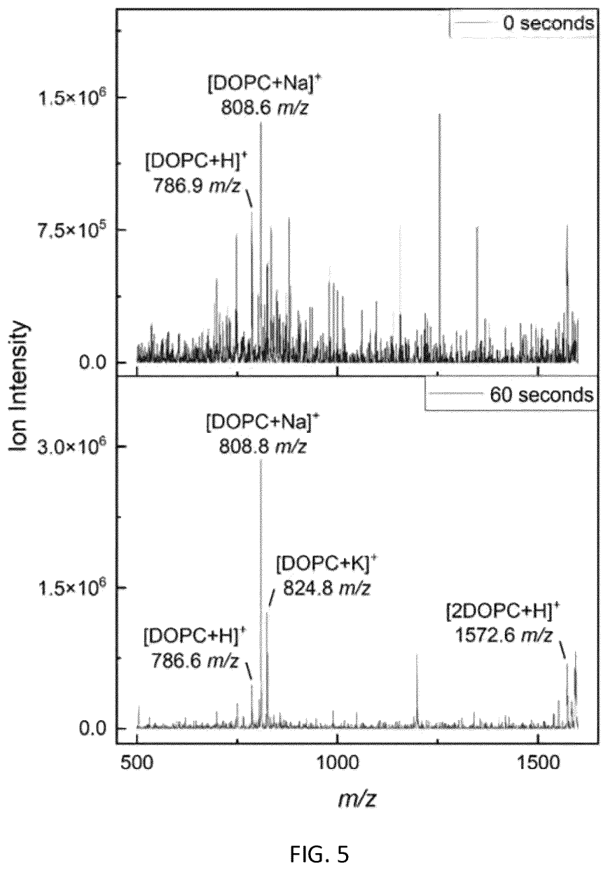

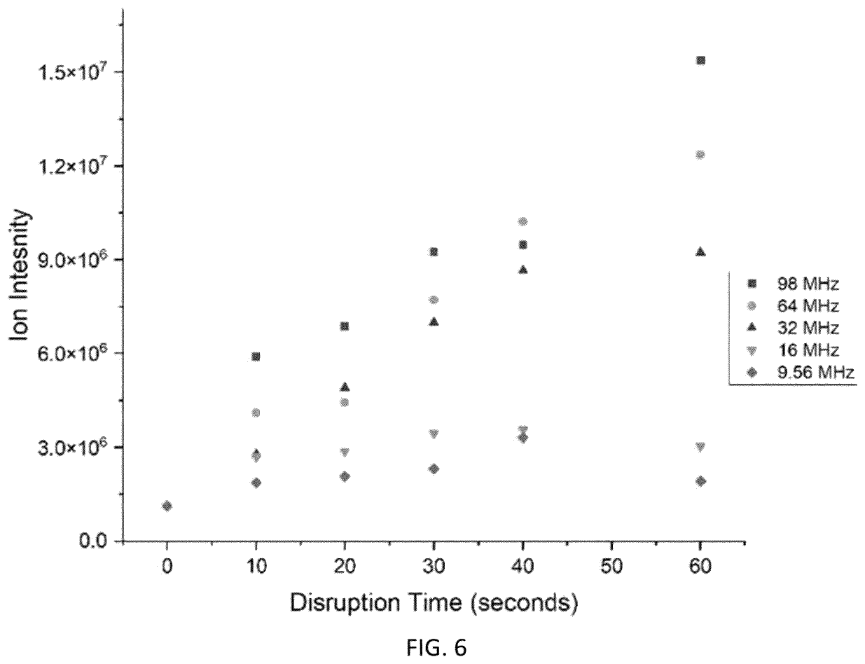

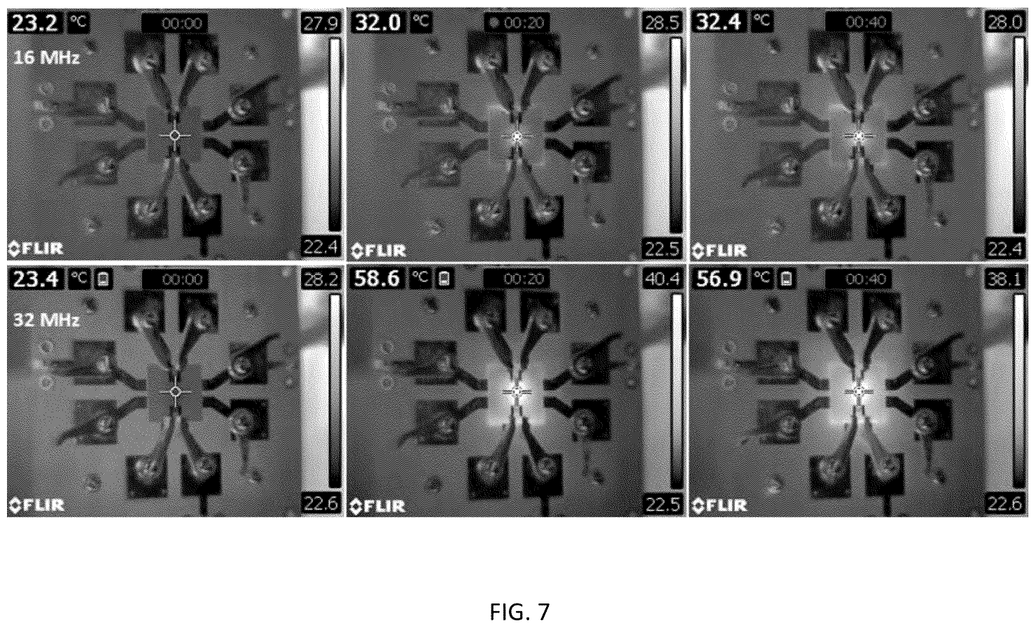

Optimization of SAW Disruption of Liposomes. We hypothesized that the SAW operation could be deliberately used to disrupt lipid aggregates and release individual lipid components. We thus adopted liposomes as an initial model, providing controlled lipid composition and size. A multipass lipid extrusion process, performed in-house, provided synthetic unilamellar liposome vesicles ˜100 nm in diameter. Liposome solutions were first investigated at a formal concentration of 127 μM DOPC in water as droplet volumes of 7 μL applied to the SAW chips. Relatively low power SAWs (˜1 W) were studied at a series of disruption frequencies using the commercial SAWN device (9.56 MHz), as well as custom fabricated SAW chips: 16, 32, 64, and 98 MHz. Exposure to the disruption frequency was conducted for 0, 10, 20, 30, 40, and 60 s. Subsequently, 1 μL aliquot droplets were then transferred to the commercial SAWN-APCI chip to be nebulized in the discrete droplet mode. Representative mass spectra of the liposome-derived lipids feature monomer and dimer DOPC ions (FIG. 5). In FIG. 6, the extracted ion intensities of these two ions are shown for the various frequencies with respect to the disruption exposure time. It is noted that without a deliberate disruption phase (i.e., 0 s), the SAWN-APCI alone yields poor lipid signal-to-noise. Generally, higher frequencies and longer exposure times result in greater DOPC signal intensity. In releasing individual lipids from the macro-structure of the 100 nm liposomes, the acoustic methods employed generally provide lipid signal proportionate with frequency and time. Cursory SAW parameters for disruption of 100 nm DOPC liposomes yielded the highest observed signals in the range of 30-60 s. While 98 MHz yielded the highest ion intensity, the chips were more susceptible to cracking. Characteristic thermal conditions of SAW disruption are reported for various chips using infrared imaging in Table 1 and FIG. 7. SAW chips at 64 MHz were subsequently chosen for their resilience and satisfactory ion signal and were used for further disruption experiments.

We estimated evaporation of ˜1 μL from the 7-μL sample volume for the 98 MHz chips past 60 seconds. Because a consistent 1 μL pipetted volume is sample to the SAWN-APCI, higher signals may be partially attributed to a concentration effect. We observed thermal behavior by infrared camera video across the duration of operation of the disruption SAW chips. Thermal data for each chip from 0-60 seconds is summarized in Table 1. Temperature differences are attributed to variation in the process of fabrication of the chips. While internal energy deposition may be indicated by formation of the PC headgroup fragment at m/z 184, significant chemical noise in the low mass range limited spectral collection >m/z 300.

TABLE 1
Thermal Data for SAW disruption referenced in FIG. 7.

| | 98 MHz | 64 | 32 | 16 | 9.56 |
|---|---|---|---|---|---|
| Time | (° C.) | MHz | MHz | MHz | MHz |
| 0 | 31 | 25.7 | 23.4 | 23.2 | 22.6 |
| 10 | 49.1 | 50.9 | 54.8 | 30.2 | 23.1 |
| 20 | 53.3 | 52.6 | 58.6 | 32 | 23.3 |
| 30 | 54.4 | 54.9 | 56.1 | 32.5 | 23.2 |
| 40 | 55.6 | 56.1 | 56.9 | 32.4 | 23 |
| 60 | 53.4 | 56.4 | 57.2 | 32.1 | 23.2 |

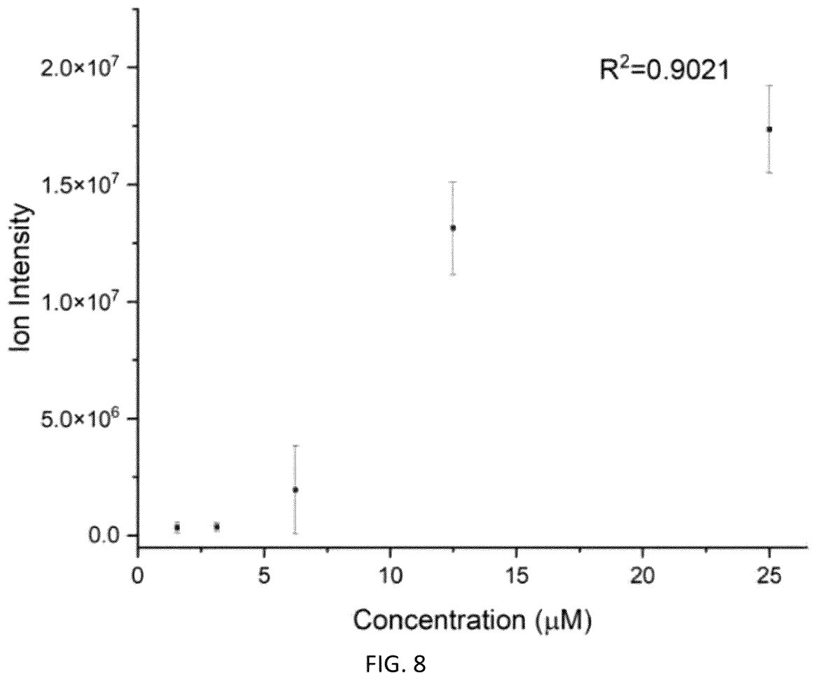

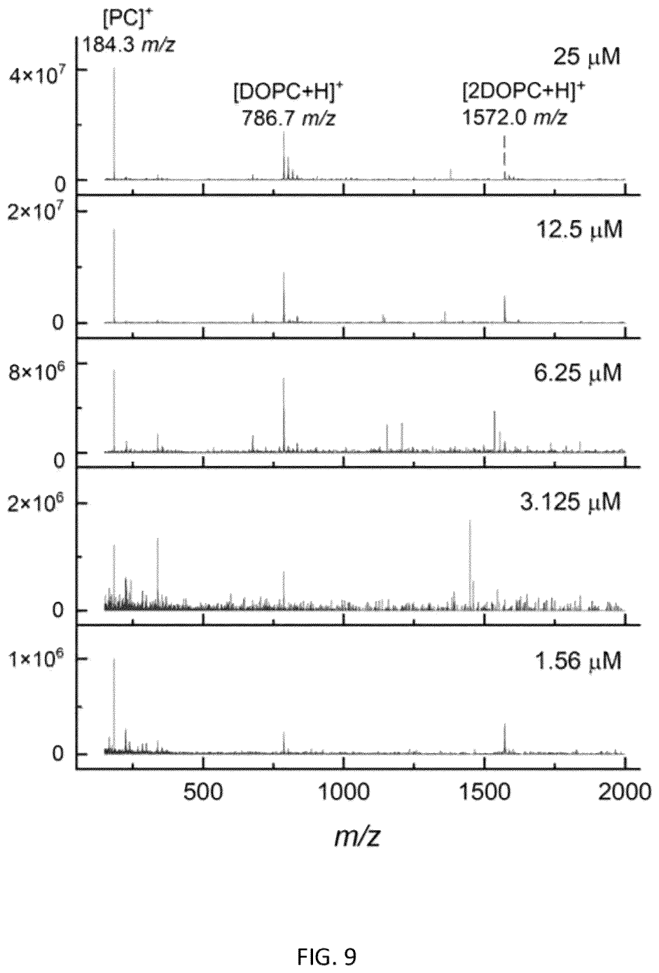

At this point, we also incorporated ammonium acetate into the aqueous solvent, which facilitated ionization at lower concentrations. To investigate particle concentration detection limits, liposomes were further studied at dilutions from 1.6 to 25 μM DOPC disrupted for 40 s at 64 MHz. In FIG. 8, ion signal from DOPC was observed down to 1.6 μM DOPC or ˜11×10⁶ liposomes/μL. At this low concentration, the ion intensity of the PC headgroup, along with DOPC's monomer and dimer, including sodium adducts, were all visible (FIG. 9). Interestingly, the nonlinear relationship of signal to concentration would indicate some self-matrix effect of DOPC across the combined use of SAW disruption and SAWN-APCI.

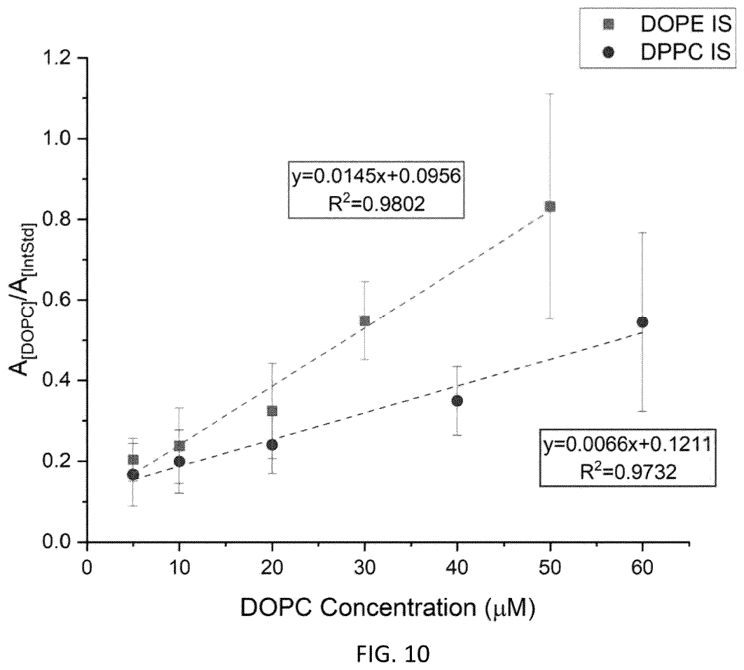

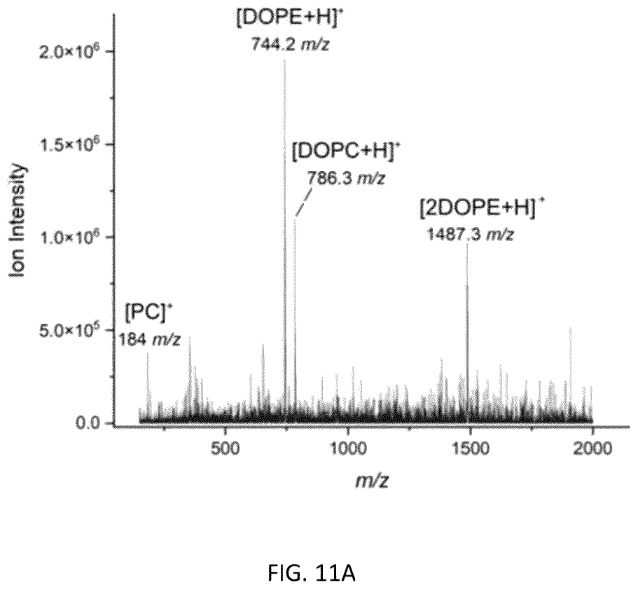

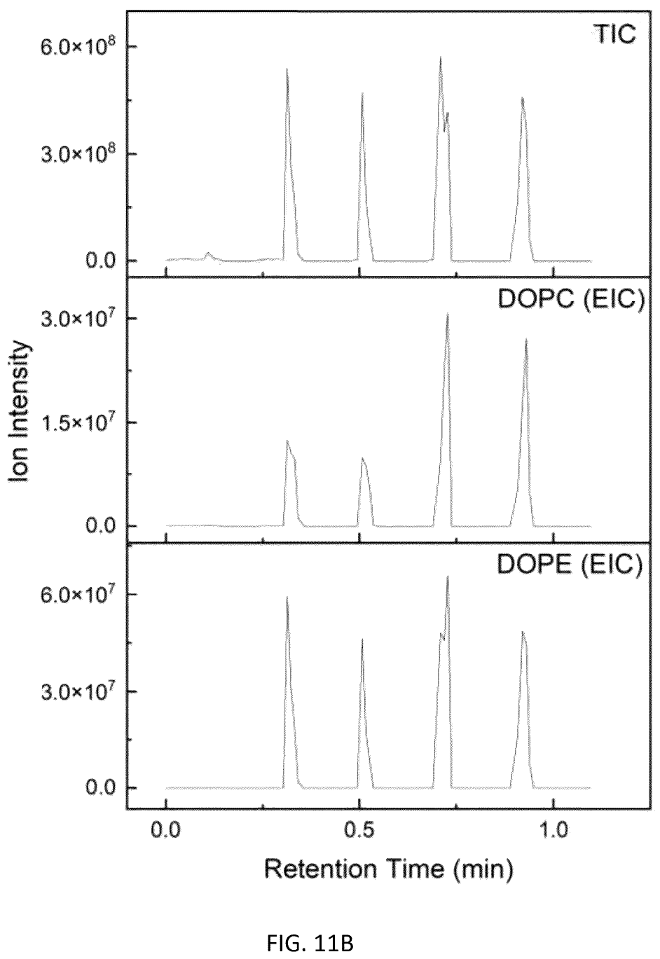

Binary Mixtures. To more quantitatively determine the lipid release from liposomes, we attempted to measure the released DOPC by including an internal standard. In FIG. 10, a calibration curve spans formal DOPC concentrations ranging from 5 to 50 μM, for which each solution was spiked with 50 μM DOPE or 25 μM DPPC. Using SAWN-APCI alone, signals were collected for multiple discrete 1 μL droplets for each of the calibrator solutions (FIG. 11A-11B). The relative ionization efficiency of the lipids DOPC to DOPE and DPPC results in signal response factors of ˜0.84 and ˜0.5, respectively. While the calibrators comprise formal lipid concentrations, we note that the extent of lipid aggregation and truly free lipids is unknown in these primarily aqueous solutions. DOPE exhibits greater ionization efficiency than OPC, but as the DOPC concentration increases, the error increases, reflecting a matrix effect due to a lower DOPE signal. We speculate that rising lipid content in water facilitates DOPC microscale aggregation with DOPE in solution at the formal concentrations studied. In the case of DPPC, similar behavior is observed but more dramatic due to a wider difference in ionization efficiency. Nonetheless, in either case, a linear calibration curve was established to assess the level of DOPC released by liposome disruption amidst the spiked internal standards.

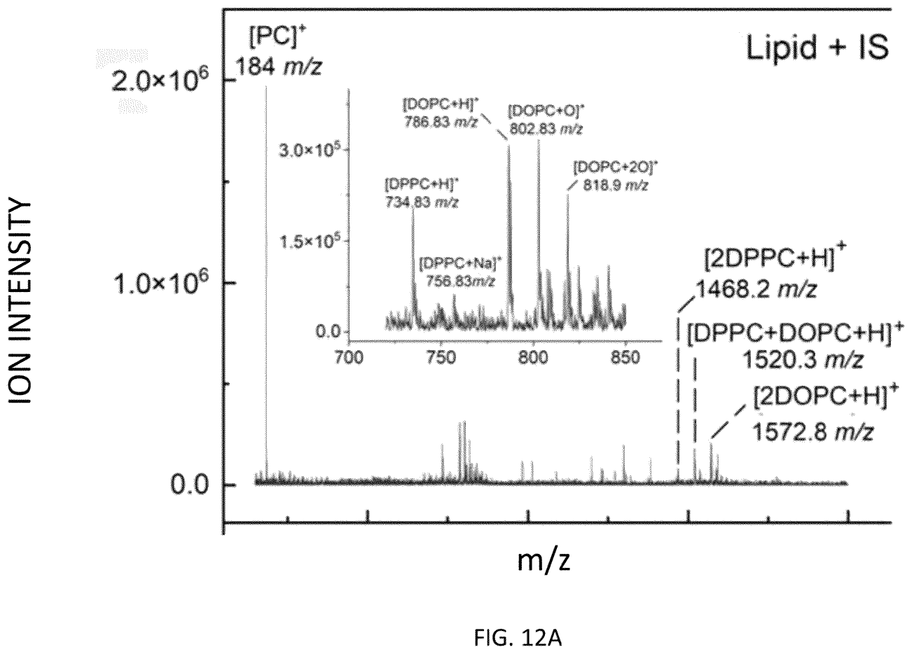

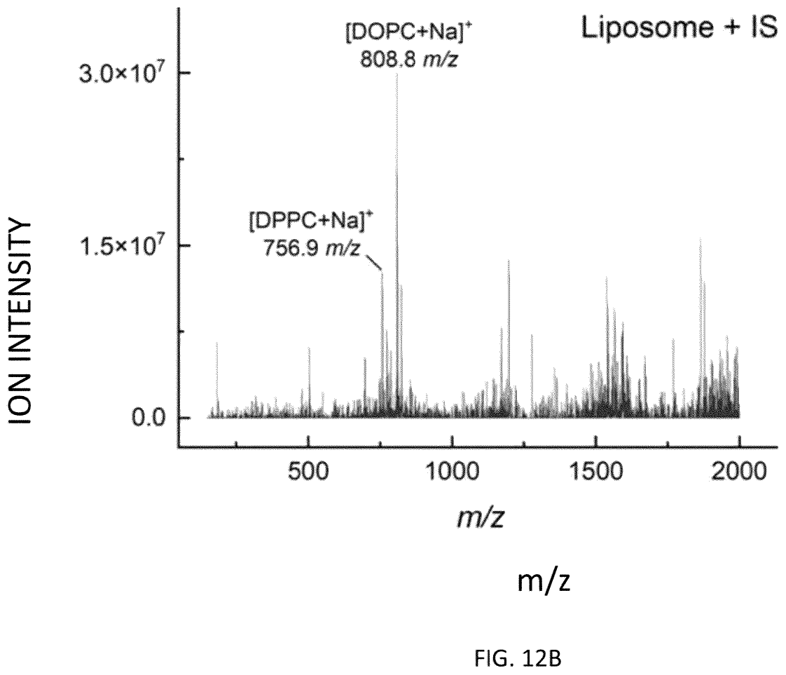

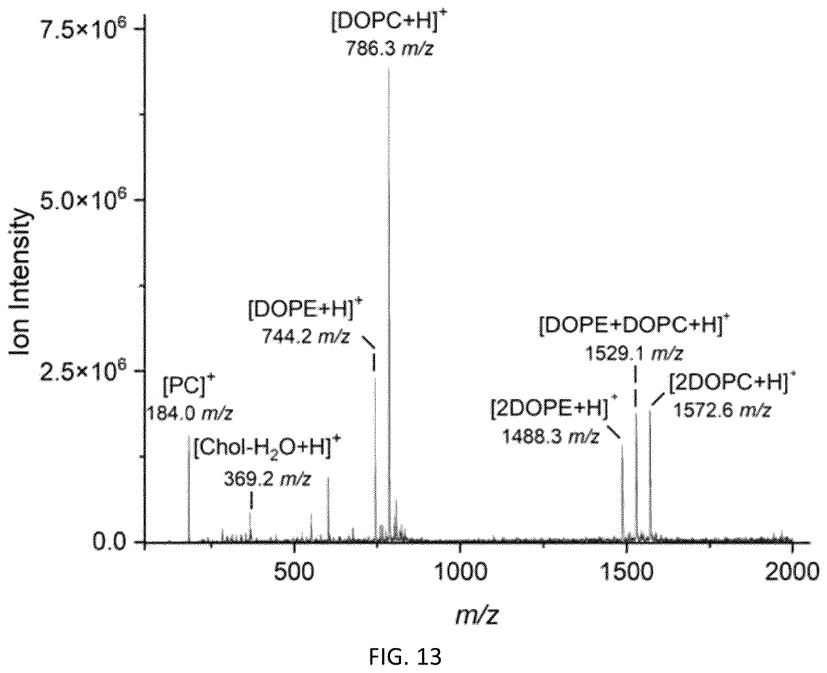

The use of DPPC as an internal standard to study the release of DOPC from liposomes was evaluated but yielded complex spectra (FIG. 12A-12B). We subsequently focused on the DOPE internal standard to quantify the release of DOPC from the liposomes while also studying the incorporation of cholesterol into the DOPC envelope. A series of liposome formulations was produced with the same total lipid concentration of 15 μM (DOPC+cholesterol) featuring 0, 2.5, 10, and 40 mol % of cholesterol. Liposomes (100 nm, 15 μM) underwent exposure to 64 MHz SAWs for 30-60 s and were then transferred in 1 μL aliquots to SAWN-APCI for MS analysis. In FIG. 13, a sample mass spectrum is shown of 10% cholesterol liposomes, spiked with 50 μM DOPE, subjected to 60 s disruption. Interestingly, the released DOPE signal appears to be relatively suppressed compared to released DOPC. Additionally notable is the fact that a heterologous dimer of DOPC and DOPE (1529.1 m/z) is comparable to that of the dimers of DOPE (1488.3 m/z) and DOPC (1572.6 m/z). Therefore, immediately following the disruption phase, individual DOPC released from the liposome readily associates with the spiked DOPE, suggesting the formation of a mixed aggregate in solution.

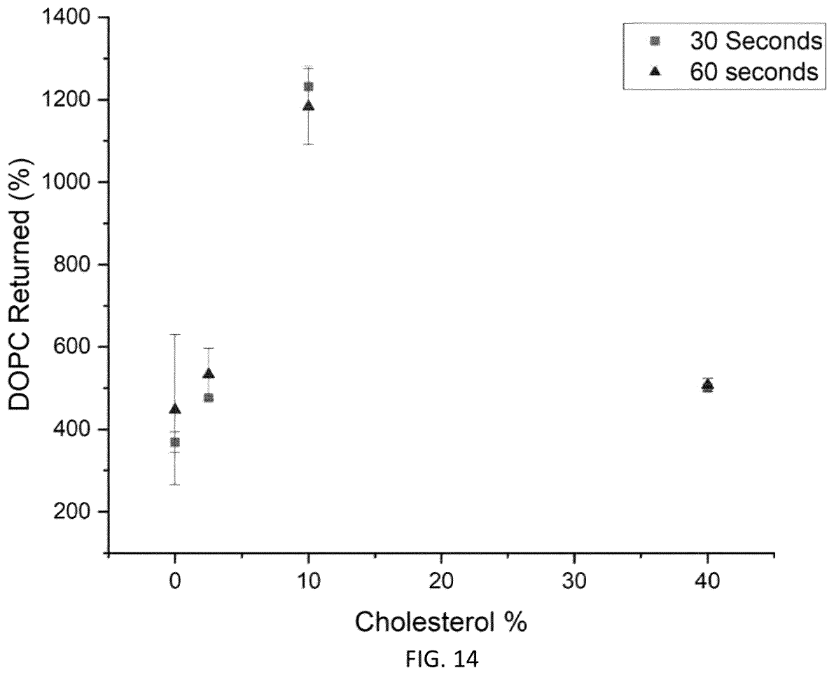

Cholesterol is generally viewed as adding rigidity to bilayer membranes, making them more robust against disruption (24). Toward characterizing this phenomenon, FIG. 14 depicts the observed DOPC released (after 30 and 60 s disruptions) across representative cholesterol incorporation that may be observed in biological membranes. Using the prior DOPE/DOPC calibration curve, the cholesterol-free liposome study at 0% shows little difference between the two disruption durations, suggesting an efficient disruption. However, closer inspection reveals an overly strong DOPC/DOPE signal yielding an unbelievably high recovery (350-450%). Therefore, even without cholesterol, we may surmise that the presence of the DOPC in liposome formation suppresses DOPE signal through reaggregation, such as the fresh formation of mixed micelles or possibly incorporation of DOPE into incompletely disrupted liposomes.

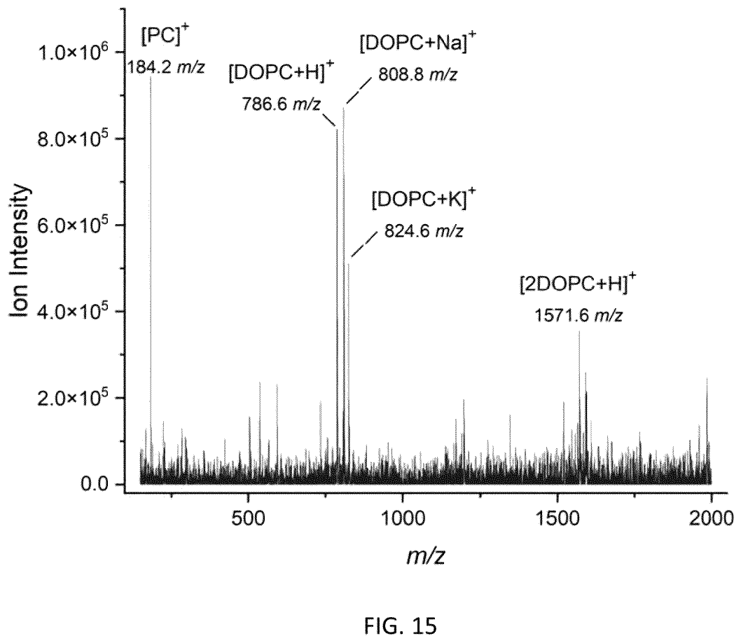

From 2.5% to 10% cholesterol, quantified DOPC increases, despite smaller formal concentrations of DOPC. At 10% cholesterol content, longer disruption yields the highest overall measurement of DOPC, but notably low and inconsistent cholesterol signal (FIG. 15). The 1230% recovery stands out, demonstrating that cholesterol has an outsized matrix effect on the overall method. Quantitation of the cholesterol itself is complicated due to its >100 times lower solubility in water than the phospholipids while the purported CMC of cholesterol is in the nM range (25). Consequently, it is reasonable that any released cholesterol may also rapidly reaggregate with both released DOPC and spiked DOPE during the transfer of the droplet to the SAWN-APCI. While such matrix effects with cholesterol incorporation are clearly significant, an extensive study is hampered by the rapid clogging of the MS inlet even at the ultimately low cholesterol concentrations.

At 40% cholesterol, quantified DOPC then returns to lower levels. In the literature, at high levels of cholesterol incorporation, interactions between DOPC's acyl chains and cholesterol's steroid ring may confer rigidity to phospholipid membrane structure. 26 Such immobilization of the phospholipids by cholesterol decreases membrane permeability and may likewise inoculate against acoustic disruption. Conversely, at lower levels of cholesterol (≤10% mol) in the bilayer, the presence of cholesterol has been associated with increased membrane fluidity. Therefore, further optimization of the SAW disruption efficiency may take into account the cholesterol composition.

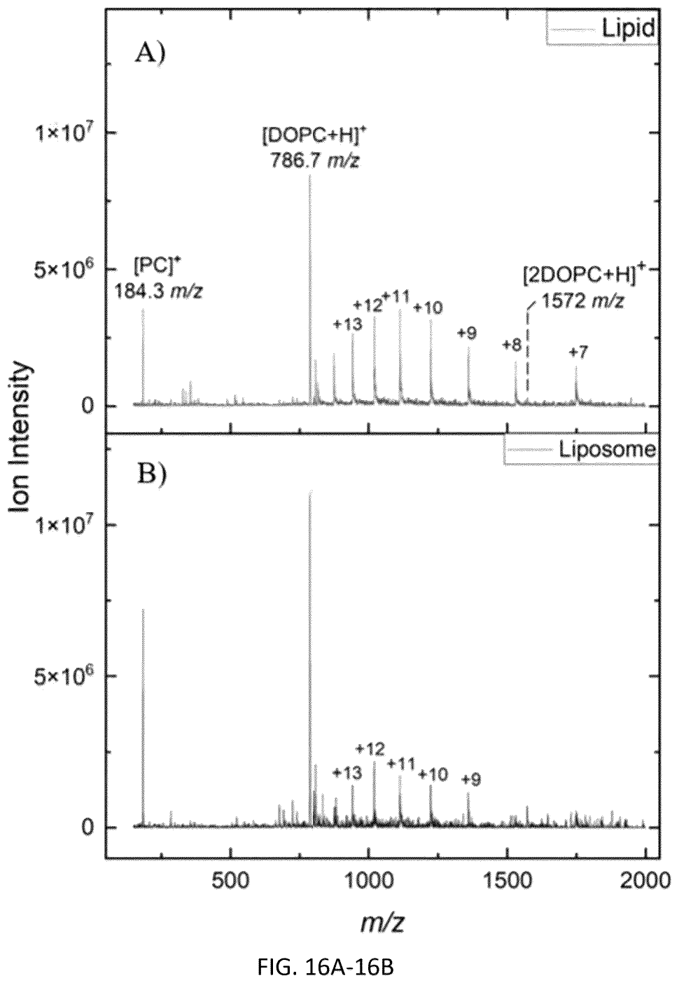

Finally, we had incidentally observed that the SAWN-APCI method demonstrated capability for small protein ionization under native conditions as similar techniques have previously. 28 In FIG. 16A, we show the mass spectrum of sampled droplets containing 14 kDa cytochrome C and spiked DOPC lipid with formal concentrations of 12.5 and 25 μM, respectively, observed by SAWN-APCI alone. In FIG. 16B, the cytochrome C is spiked into the DOPC liposome solution (not incorporated into the liposomes themselves), which is then subjected to 40 s of 64 MHz SAWs prior to SAWN-APCI. Cytochrome C signal is still recovered but may be subtly influenced by the disruption phase. One feature of these spectra worth mentioning, the dominant charge states of +11 and +12 indicates relatively unfolded conformations of the cytochrome C. Additionally, regarding the DOPC lipid, headgroup signal is outsized in the liposome, suggesting complex internal energy deposition.

### DISCUSSION

SAWN-APCI provides a similar signal to ESI and successfully ionizes both polar DOPC and nonpolar cholesterol, potentially mitigating matrix complications in lipidomics assays. SAWNAPCI by itself is primarily advantageous, as there is no narrowbore emitter to clean and any potential lipid aggregates are dispersed during nebulization. High frequency SAWs have been shown to release DOPC lipids from liposomes even those including cholesterol. On the other hand, cholesterol incorporation results in matrix effects that ultimately impact disruption efficiency. Using DOPE as an internal standard, we attempted to assess the recovery and the efficiency of the disruption SAW by calibration. Across all liposomes, the recovered DOPC was higher than the initial DOPC concentration.

Overall, liposomes systematically processed by acoustics reveal a promising mechanical alternative to chemical lysis. The methods explored support a broadband analysis using sustained (>30 s) high frequency (>64 MHz) disruption SAW without the use of chemical lysing agents. Liposomes down to concentrations of 1.6 μM DOPC or ˜11×10⁶ liposomes/μL were detectable from 1 μL which may prove particularly beneficial for precious, low-volume samples and for potentially high-throughput applications. Additional studies showing the operation of SAWs on aqueous solutions are relevant to potential native mass spectrometry applications of higher order structures between lipids and proteins. Future work of the SAW technology may thus impact the study of lipid aggregates, extracellular vesicles, and lipid-protein complexes.

### REFERENCES

(1) Large, D. E.; Abdelmessih, R. G.; Fink, E. A.; Auguste, D. T. Adv. Drug Delivery Rev. 2021, 176, 113851-113864.
(2) Colombo, M.; Raposo, G.; Thery, C. Annu. Rev. Cell Dev. Biol. 2014, 30 (1), 255-289.
(3) Wang, J.; Wang, C.; Han, X. Anal. Chim. Acta 2019, 1061, 28-41.
(4) Frick, M.; Schwieger, C.; Schmidt, C. Angew. Chem. 2021, 60 (20), 11523-11530.
(5) Frick, M.; Schmidt, C. Chem. Phys. Lipids 2019, 221, 145-157.
(6) Simpson, R. J.; Lim, J. W.; Moritz, R. L.; Mathivanan, S. Expert review of proteomics 2009, 6 (3), 267-283.
(7) Koivusalo, M.; Haimi, P.; Heikinheimo, L.; Kostiainen, R.; Somerharju, P. J. Lipid Res. 2001, 42 (4), 663-672.
(8) Yang, K.; Han, X. Metabolites 2011, 1 (1), 21-40.
(9) Song, L.; You, Y.; Evans-Nguyen, T. Anal. Chem. 2019, 91 (1), 912-918.
(10) Song, L.; You, Y.; Perdomo, N. R.; Evans-Nguyen, T. Anal. Chem. 2020, 92, 11072-11079.
(11) Sankaranarayanan, S. K. R. S.; Singh, R.; Bhethanabotla, V. R. J. Appl. Phys. 2010, 108 (10), 104507.
(12) Li, S.; Bhethanabotla, V. R. Sensors (Basel) 2019, 19 (18), 3876-3888.
(13) Taller, D.; Richards, K.; Slouka, Z.; Senapati, S.; Hill, R.; Go, D. B.; Chang, H.-C. Lab Chip 2015, 15 (7), 1656-1666.
(14) Nsairat, H.; Khater, D.; Sayed, U.; Odeh, F.; Al Bawab, A.; Alshaer, W. Heliyon 2022, 8, e09394.
(15) Lombardo, D.; Kiselev, M. A. Pharmaceutics 2022, 14 (3), 543.
(16) Alves, N. J.; Cusick, W.; Stefanick, J. F.; Ashley, J. D.; Handlogten, M. W.; Bilgicer, B. Analyst 2013, 138, 4746-4751.
(17) Marsh, D. Handbook of Lipid Bilayers; CRC Press, Inc.: Max-Planck-Institut für biophysikalische Chemie: Gottingen, Germany.
(18) Hauner, I. M.; Deblais, A.; Beattie, J. K.; Kellay, H.; Bonn, D. J. Phys. Chem. Lett. 2017, 8, 1599-1603.
(19) Prajapati, K.; Patel, S. Arch. Appl. Sci. Res. 2012, 4 (1), 662-668.
(20) Esteban, B.; Riba, J.-R.; Baquero, G.; Puig, R.; Rius, A. Fuel 2012, 102, 231-238.
(21) Brown, R. E. Biochim. Biophys. Acta 1992, 1113 (0), 375-389.
(22) Walczak, J.; Bocian, S.; Buszewski, B. Food Analytical Methods 2015, 8, 661-667.
(23) Shelley, J. T.; Wiley, J. S.; Chan, G. C. Y.; Schilling, G. D.; Ray, S. J.; Hieftje, G. M. J. Am. Soc. Mass Spectrom. 2009, 20 (5), 837-844.
(24) Briuglia, M.-L.; Rotella, C.; McFarlane, A.; Lamprou, D. A. Drug Delivery and Transl. Res. 2015, 5, 231-242.
(25) Haberland, M. E.; Reynolds, J. A. Proc. Natl. Acad. Sci. U.S.A 1973, 70 (8), 2313-2316.
(26) Mainali, L.; Feix, J. B.; Hyde, J. S.; Subczynski, W. K. Journal of Magentic Resonance 2011, 212, 418-425.
(27) Subczynski, W. K.; Pasenkiewicz-Gierula, M.; Widomska, J.; Mainali, L.; Raguz, M. Cell Biochem. Biophys. 2017, 75 (3-4), 369-385.
(28) Marcus, R. K.; Hoegg, E. D.; Hall, K. A.; Williams, T. J.; Koppenaal, D. W. Mass Spectrom. Rev. 2023, 42, 652-673.

### Additional Applications

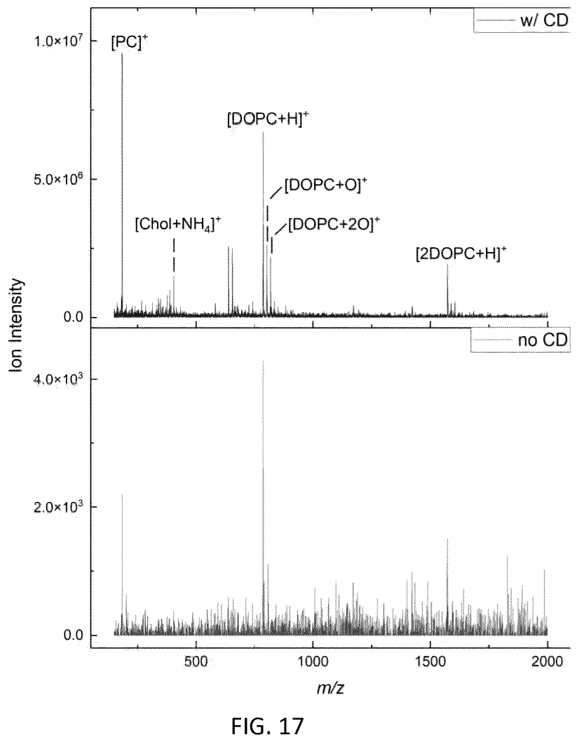

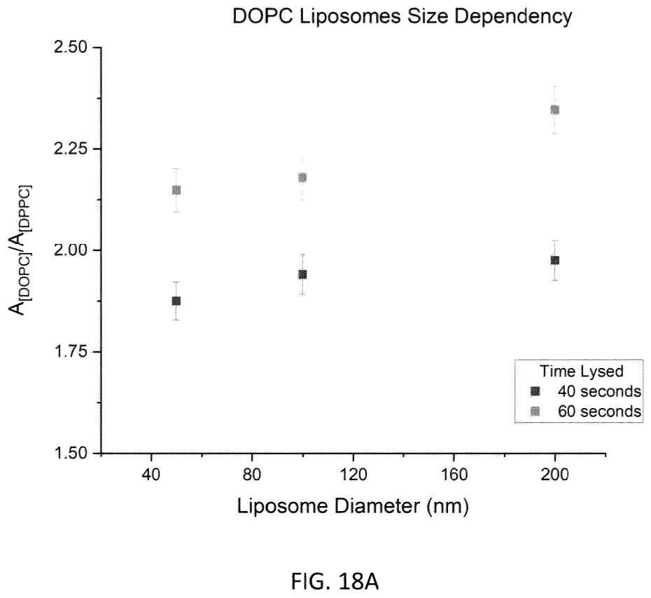

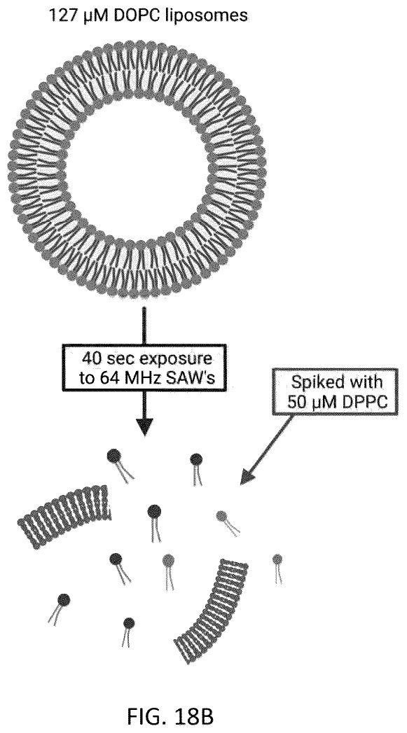

Impact of Corona Discharge. FIG. 17 shows the mass spectrum of a sample with and without CD. There is high ionization efficiency for SAWN alone. There is a 4-fold increase in signal with CD (note the y-axis of the two plots). In addition, we can see nonpolar cholesterol in most SAWN-CD spectra. The sample shown in FIG. P includes 12.5 μM cholesterol with 40 μM DOPC in 10 mM ammonium acetate, 4:1 MeOH/ChCl₃ 25 μL/min. DOPC Liposomes Size Dependency. FIGS. 18A-18B show DOPC liposomes spiked with DPPC from different sizes. The liposomes were disrupted for 40 seconds (bottom data points) and 60 seconds (top data points) using a 64 MHz SAW chip. A size dependency internal standard of DOPC/DPPC was used to analyze disruption efficiency. An overview of the lysing steps of this application is shown in FIG. 18B.

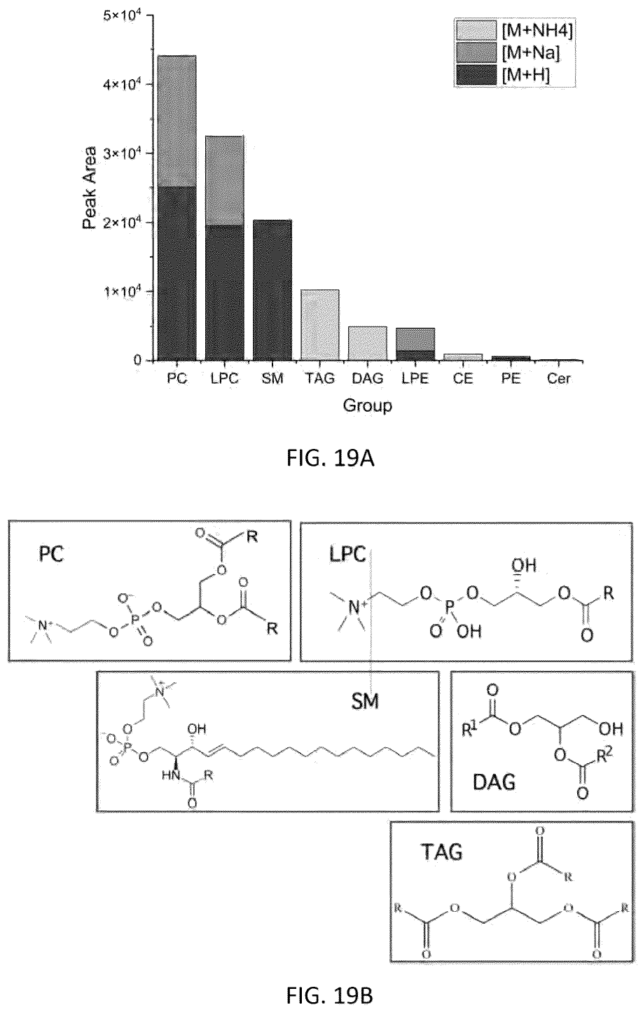

Lipodomic profile of exosomes. FIG. 19A-19B shows the lipodomic profile of exosomes. The sample was collected from adipose tissue exosomes in 150 mM ammonium acetate water, and were collected with SAW-SAWN-CD-FAIMS in the continuous mode. These samples used a 60 second exposure to 64 MHz SAWs then 3 kDa centrifugal filter. In FIG. 19B, the chemical structures of the five most abundant chemical structures are shown.

### Two Chip Fabrication

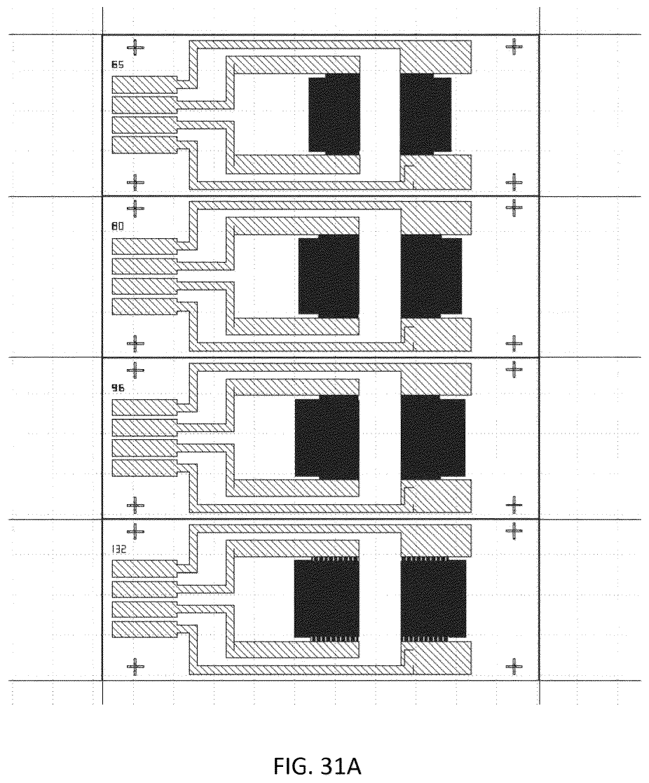

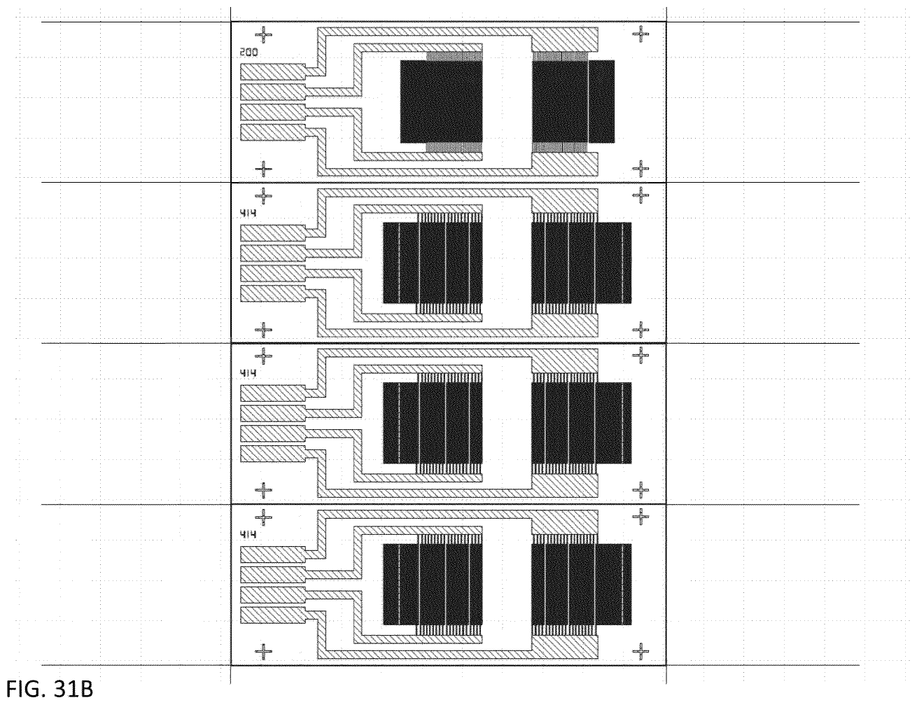

When two chips are being used for SAW disruption and nebulization, each chip can be controlled by a single stage (e.g., a disruption stage and a nebulization stage). Example stages schematics are shown for stages designed for 30 to 60 MHz (FIG. 31A) and 10 and 20 MHz (FIG. 31B). Potential parameters are summarized in Table 2.

TABLE 2
SAW device parameters.

| | | | | Delay | | |
|---|---|---|---|---|---|---|
| | Wave- | IDT | Reflector | line | | Finger |
| Frequency | length | aperture | aperture | Length | Reflector | Pair |
| (MHz) | λ (μm) | (mm) | (mm) | (mm) | # | # |
| 9.32 | 414 | 10 | 10.2 | 6.2 | 20 | 20 |
| 19.6 | 200 | 10 | 10.2 | 6.2 | 30 | 35 |
| 29.56 | 132 | 9.4 | 9.6 | 5.2 | 32 | 60 |
| 40.56 | 96 | 9.4 | 9.6 | 5.2 | 60 | 60 |
| 49.45 | 80 | 9.2 | 9.4 | 5.2 | 64 | 64 |
| 59.95 | 65 | 9 | 9.2 | 5.0 | 64 | 64 |

### Example Two—One Chip Approach

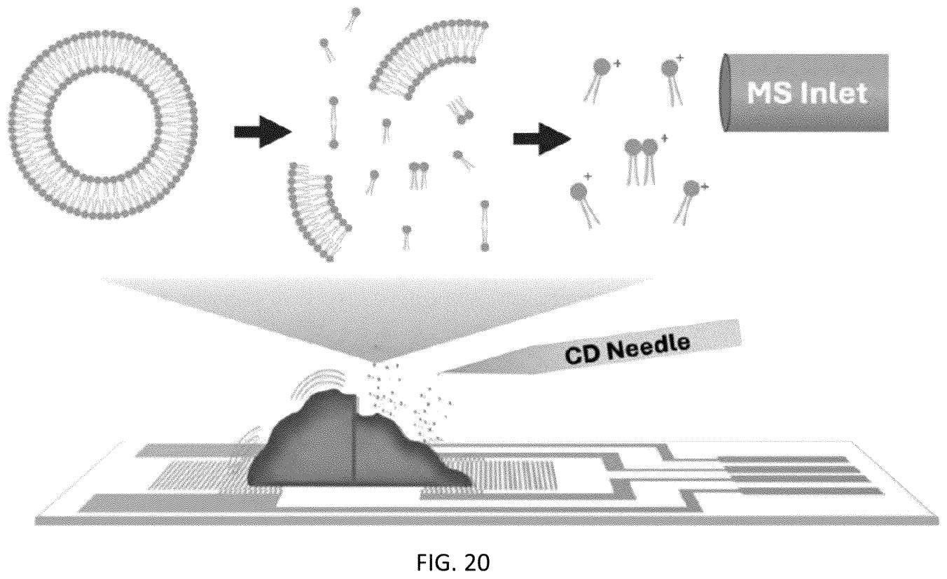

In Example Two, a single chip can be used for SAW disruption and nebulization. This one chip design uses high frequency surface acoustic wave chip for disruption at 1 watts. After 20-40 seconds, power increases to induce nebulization. An aerosolized sample will interact with a high voltage CD needle to ionize before entering the MS for analysis (see FIG. 20).

### One Chip Fabrication

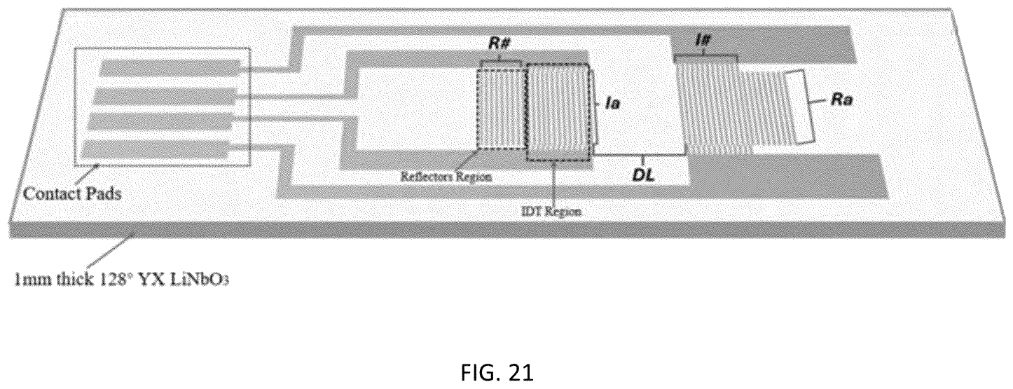

SAW devices feature two regions of interdigital transducers (IDTs), each composed of identical pairs of electrode fingers. Adjacent to these IDT regions are reflectors patterned with ¼ of the IDT wavelength for SAW reflection (see FIG. 21). Various resonant frequencies are designed by altering the IDT periodicities by considering the SAW propagation speed at 3960 m/s. The IDT resonant frequencies, wavelengths, IDTs and reflectors apertures (Ia/Ra), delay line length (DL), reflectors numbers (R #) and IDT finger pair numbers (I #) are listed in Table 2.

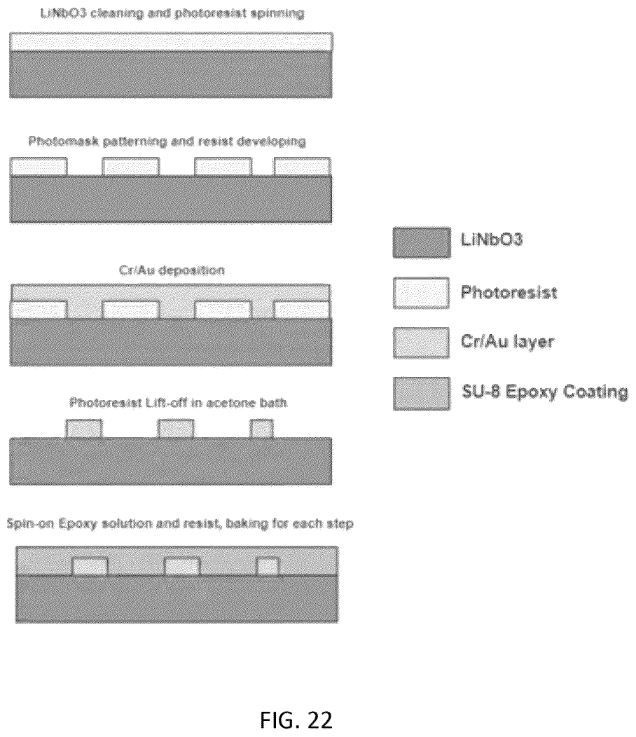

The fabrication process starts with a cleaned 4-inch 128° YX lithium niobate substrate. The substrate is 1 mm thick and is double-sided polished. NR-9 1500py (Futurrex) negative photoresist was spin-coated to reach a thickness of 2 μm, followed by a 2 min, 125° C. pre-bake. After UV exposure (Karl Suss MA-56 Mask Aligner) and post-bake (2 min, 125° C.), the photoresist pattern is developed in Resist Developers RD6 for 14 s soaking. A 10/100 nm Cr/Au layer is e-beam evaporated (AJA) onto the substrates, followed by acetone soak for photoresist lift-off. After that, an epoxy-based negative photoresist (SU-8 2002) was spin-coated on the wafers under 7000 rpm spin rate (see FIG. 22 for schematic of fabrication). The substrate is then followed by a 1 min, 95° C. soft bake, 30 s UV exposure, as well as 10 min 175° C. curing to achieve a thickness of 1.4 μm. Noted that the photoresist on the contact metal pads as well as the delay line region in between the IDTs has been removed to prevent electrical insulation as well as reduce device heating under high RF power. The device is then treated with oxygen plasma for 3 mins at 300 torr pressure to increase the surface energy at the delay line region, which can reduce the contact angle of the sample and achieve better nebulization rate at higher frequencies.

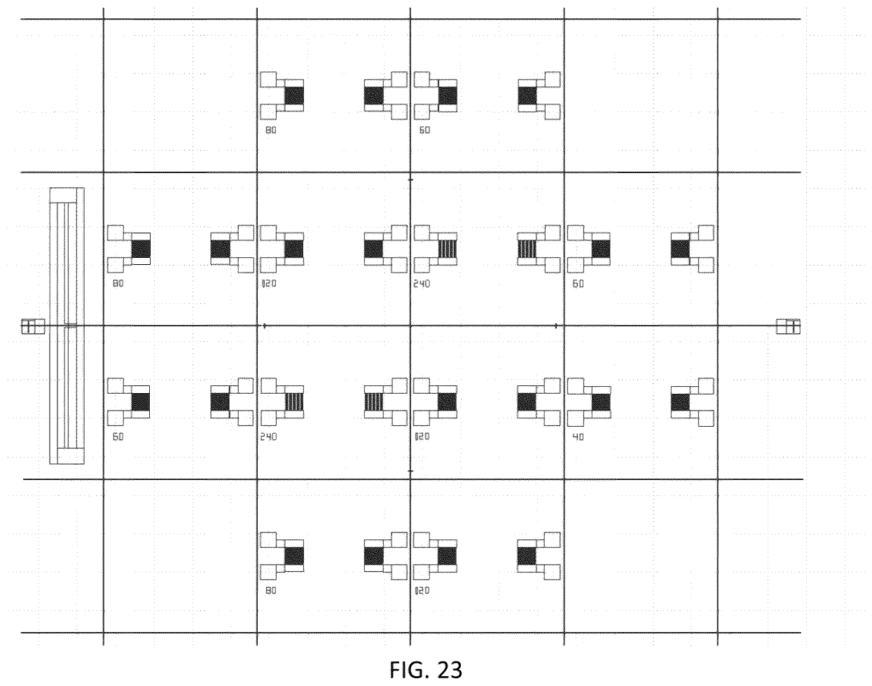

A more detailed example of the fabrication is shown in FIG. 23. Device parameters for the single chip SAW disruption device are summarized in Table 3.

TABLE 3
Two-stages SAW disruption device parameters.

| | | IDT | Delay line | |
|---|---|---|---|---|
| Frequency | Wavelength | aperture | Length | |
| (MHz) | λ (μm) | (mm) | (mm) | Finger Pair # |
| 16.3 | 240 | 2 | 8 | 10 |
| 32.7 | 120 | 2 | 8 | 20 |
| 65.3 | 60 | 2 | 8 | 40 |
| 98 | 40 | 2 | 8 | 60 |

### Applications

Methods. The SAW/SAWN chips used in these applications were: 9.5 MHz, 20 MHz, and 40 MHz. The sample analyzed in these application was: 100 mm DPPC (1,2-dipalmitoyl-sn-glycero-3-phosphocholine) liposomes. The concentration was 50 μM, and the solvent conditions were 150 mM ammonium acetate water. The MS used in this example was the Thermo Scientific Linear Ion Trap. The parameters used where: 3 microscans; 200 ms injection time; 50-75 V source fragmentation; and 0.5 μL-2 μL sample volume.

Instant Nebulization. 2 μL of sample (50 μM DPPC liposomes in 150 mM ammonium acetate water) were placed on SAW chip between the IDTs. The power was turned on to induce nebulization. 25 V source fragmentation was used.

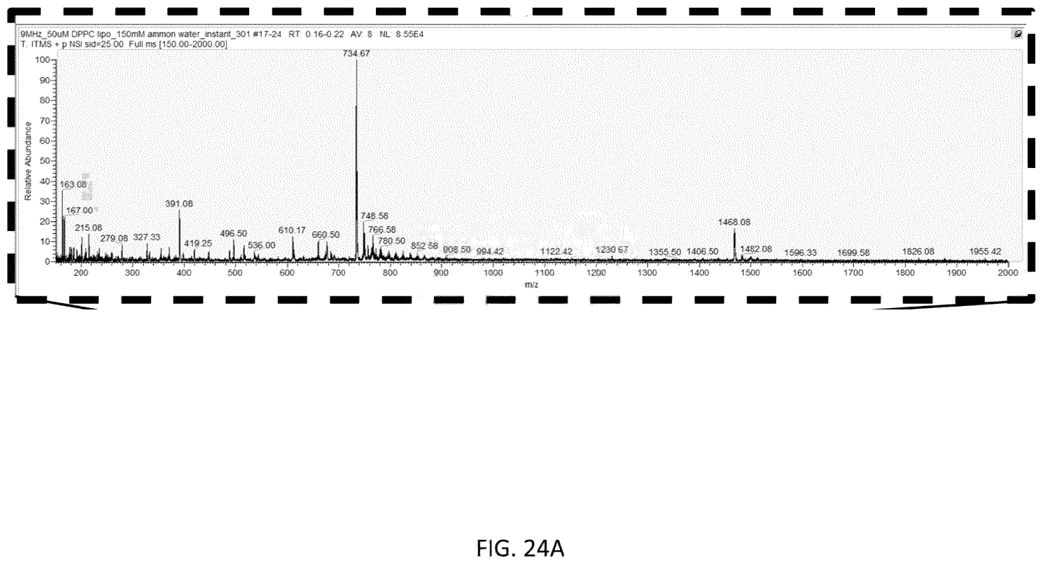

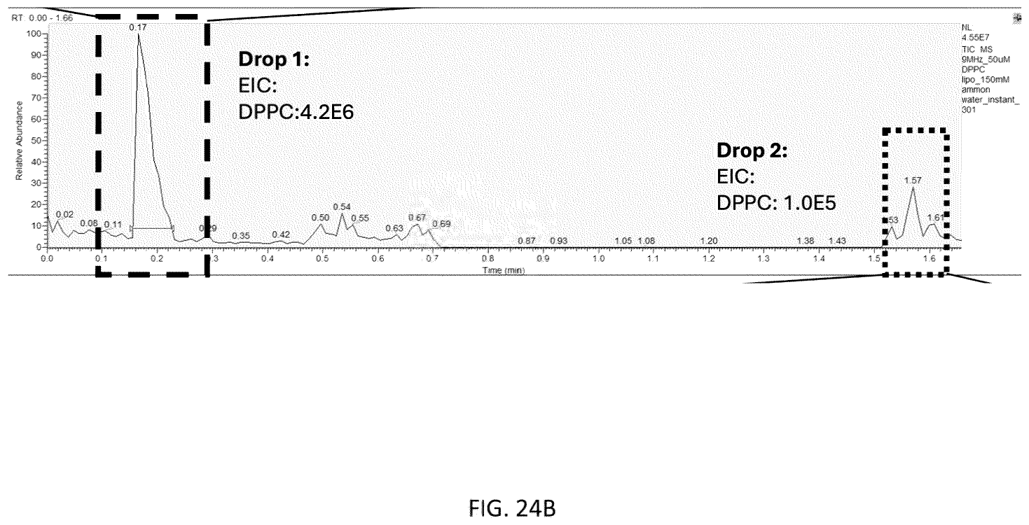

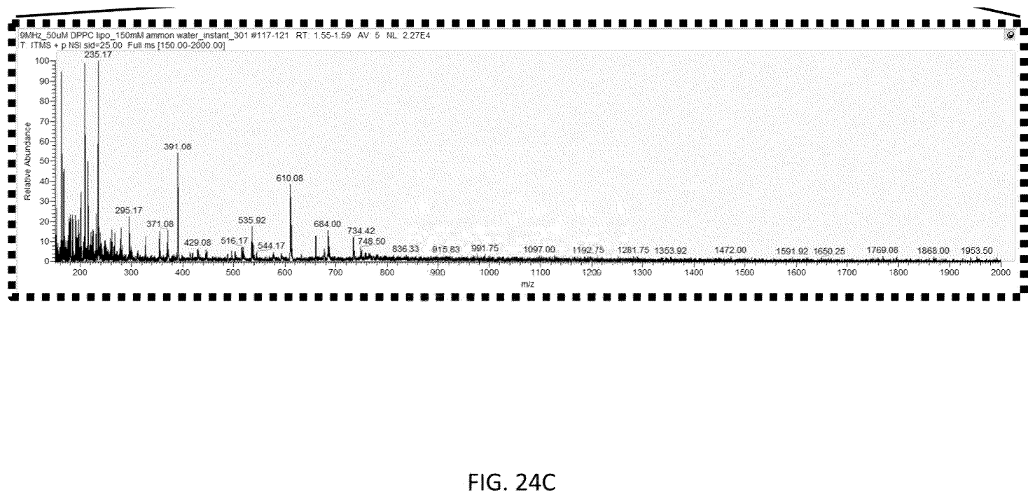

Two drops were analyzed in this trial to see if the ion intensity would dimmish after multiple drops of unlysed sample were nebulized in the instrument. The first drop containing 2 μL of sample was nebulized at 0.16 minutes. The second drop containing 2 μL of sample was nebulized at 1.54 minutes (see FIGS. 24A-24C). After the first drop was analyzed, the overall ion signal went down, indicating clogging of the ion transfer tube.

Lysing prior to Nebulization: 2 μL of 50 μM DPPC liposomes were placed on SAW chip. The power was turned to 1 Watt to lyse the 100 nm liposomes. After 20 or 40 seconds, the power was turned on to 7.25 watts to induce nebulization. 75 V source fragmentation was used.

For 40 MHz, the ion intensity was recorded for the PC headgroup (184 m/z), DPPC monomer (734 m/z), and DPPC dimer (1468 m/z).

TABLE 4
Time lysed and ion intensity.

| Time Lysed | Ion Intensity |
|---|---|
| 0 | 7351581 |
| 40 | 11005170.1 |

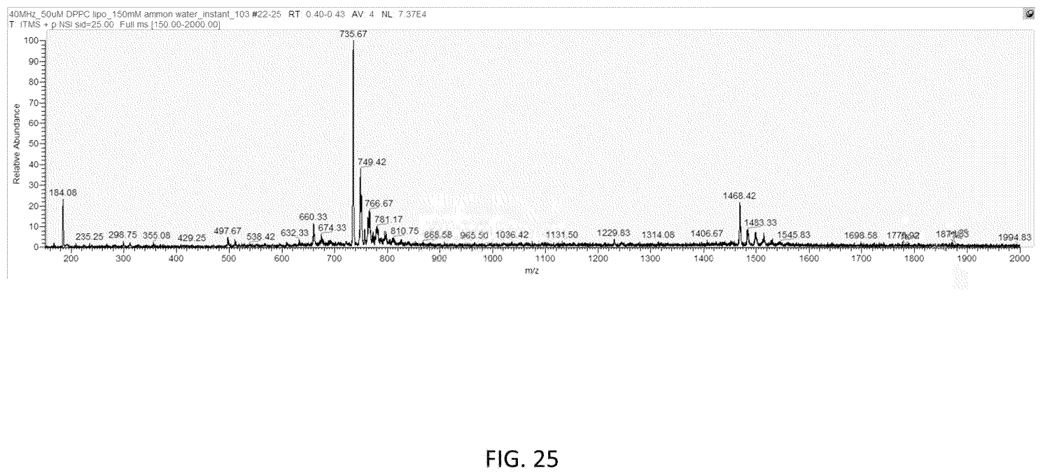

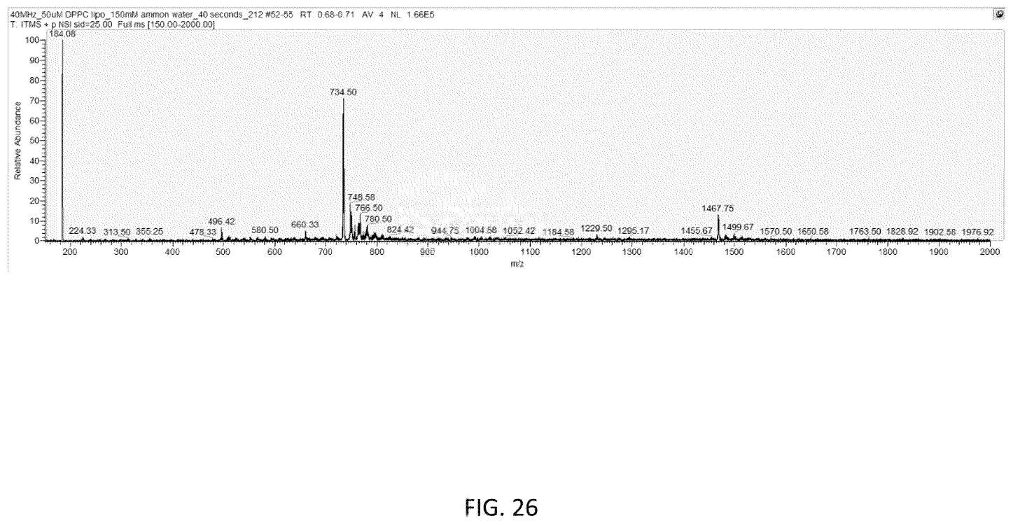

FIG. 25 shows the mass spectrum of DPPC liposomes after instant nebulization with 40 MHz. FIG. 26 shows the mass spectrum of DPPC liposomes after 40 seconds of 40 MHz SAWs. A 33% increase in ion signal after 40 seconds of lysing. In addition to the signal increase, there was no decrease in total ion signal in subsequent drops when the sample was lysed for 40 seconds. There was a decrease in total ion signal after the liposomes were instantly nebulized into the instrument.

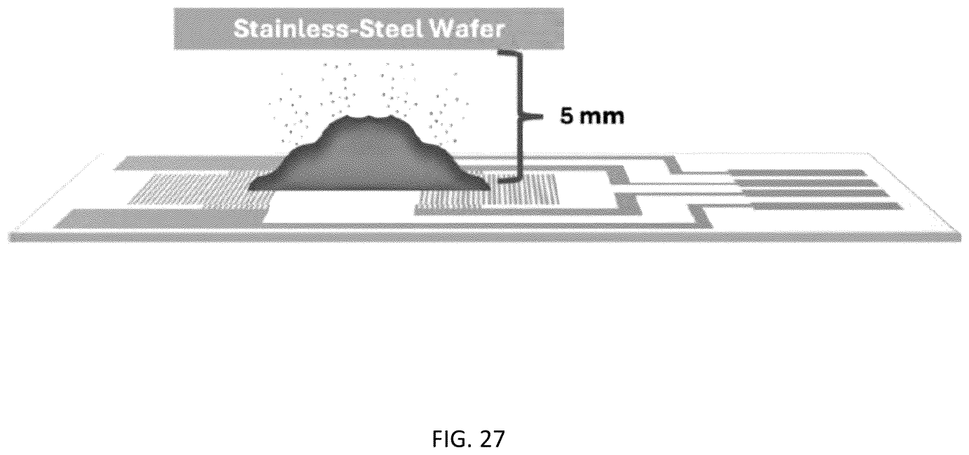

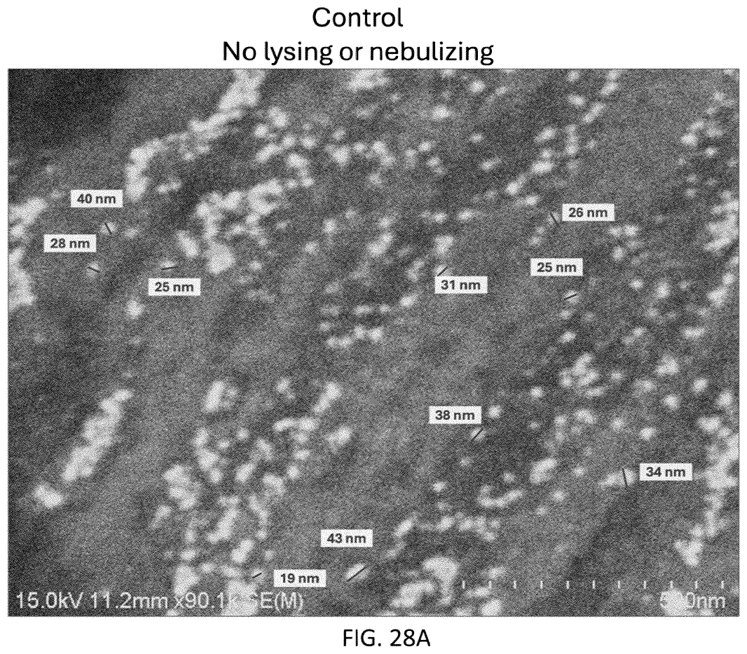

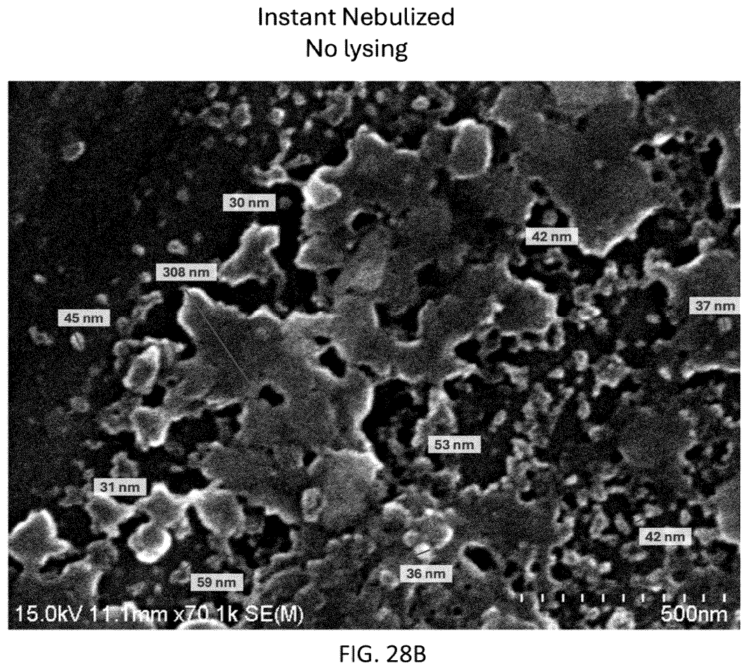

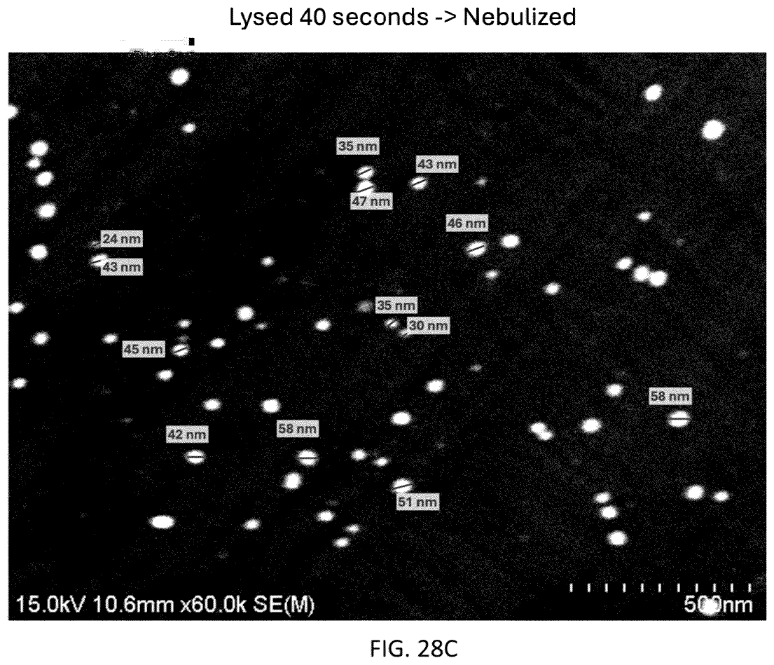

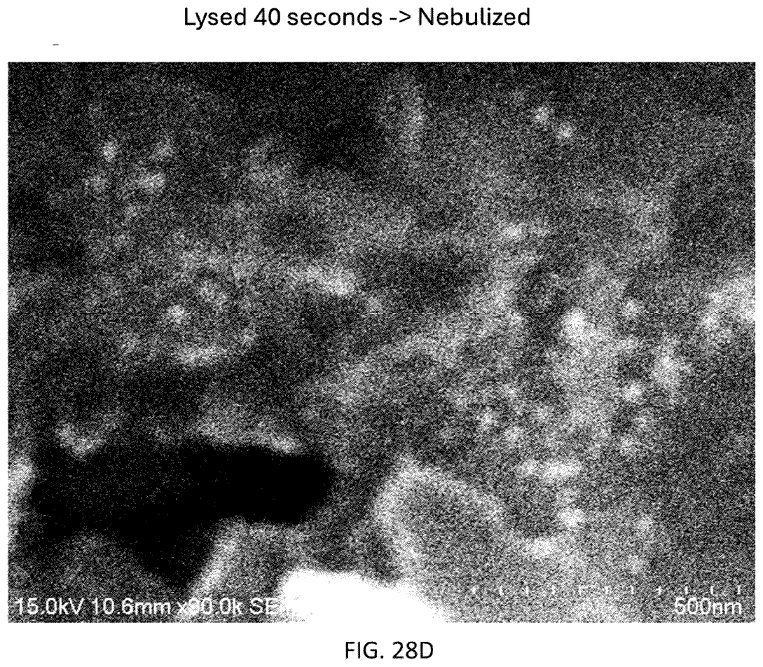

Samples Nebulized Directly on Wafer. FIG. 27 shows an overview of nebulized sample to stainless steel wafer. FIGS. 28A-28D show DPPC liposomes before and after exposure to 40 MHz SAWs. In FIG. 28A, the liposomes were placed on a stainless-steel wafer, before being fixed. In FIG. 28B, the liposomes were nebulized directly onto the stainless-steel wafer from 5 mm above the SAWN chip, shown in FIG. 7. In FIG. 28C, the liposomes were lysed for 40 seconds at 40 MHz (1 watt) before being nebulized onto the wafer for SEM analysis. All samples were treated with 4% paraformaldehyde for 10 minutes. The samples were sputtered with gold/palladium and analyzed using a Hitachi 3700 SEM.

In FIG. 28A, defined liposomes were shown clearly. The liposomes appear to be uniform in size and in large quantities. Little dispersion of the liposomes was present with this sample, likely due to the aggregation effect. Some aggregation took place, which is indicated by the larger groups of liposomes. The control had no acoustic activation.

In FIG. 28B, the liposomes were instantly nebulized onto the wafer. The liposomes appear deformed and larger in size compared to the control. There are globular looking structures throughout the images. This cloud-like clumps could be aggregation happening from the disrupted lipids. Further research needs to be conducted to understand fundamentally what is happening.

In FIG. 28C, the liposomes lysed for 40 seconds before being nebulized onto the wafer. The individual liposomes were spread out from each other more so than in the control. FIG. 28D is another image from the 40 second lysed sample. This image also shows the cloud-like figures that were present in the instant nebulized sample. While the majority of liposomes were still distinct in size, some liposomes were smaller (down to 18 nm) compared to others, where the upper limit was 60 nm.

### Example 3—Illustrative Methods

FIG. 29 shows a block diagram for a process 2900 of preparing macromolecular structures for analysis using a single SAW device. The process includes placing a molecular sample on a surface acoustic wave (SAW) device 2902. The SAW device may include a piezoelectric surface, a first transducer in contact with the piezoelectric surface, a second transducer in contact with the piezoelectric surface, and a sample region disposed between the first transducer and the second transducer and configured to receive the macromolecular sample. In some embodiments, the sample region may be configured to remain electrically isolated from the first transducer and the second transducer. The process further includes applying disruption electrical energy to transform the macromolecular sample into a disrupted macromolecular sample 2904. The disruption electrical energy used at 2904 can include a disruption frequency and a disruption power, and may be applied to the first and second transducer. The process further includes applying nebulization electrical energy to transform the disrupted macromolecular sample into a nebulized macromolecular sample 2906. The nebulization electrical energy used at 2906 can include a nebulization frequency and a nebulization power, and may be applied to each of the first and second transducer.

FIG. 30 shows a block diagram for a process 3000 of preparing macromolecular structures for analysis using two SAW devices. Process 3000 can include providing a first SAW device 3002. The first SAW device can include a first piezoelectric surface, a first pair of transducers in contact with the first piezoelectric surface, and a first sample region disposed between the first pair of transducers. The first sample region may be configured to remain electrically isolated from each of the first pair of transducers. The process can then include placing a macromolecular sample on the first SAW device 3004, and applying disruption electrical energy to transform the macromolecular sample into a disrupted macromolecular structure 3006. The disruption electrical energy applied at 3006 can include a disruption frequency and a disruption power, and may be applied to each of the first pair of transducers. The process can also include providing a second SAW device 3008. The second SAW device can include a second piezoelectric surface, a second pair of transducers in contact with the second piezoelectric surface, and a second sample region disposed between the second pair of transducers. The second sample region can be configured to remain electrically isolated from each of the second pair of transducers. The process 3000 can also include applying nebulization electrical energy to transform the disrupted macromolecular sample into a nebulized macromolecular sample 3010. The nebulization energy used at 3010 can include a nebulization frequency and a nebulization power, and may be applied to each of the second pair of transducers.

### Example 4—Extracellular Vesicles Prepared and Analyzed with a Two-Chip Workflow

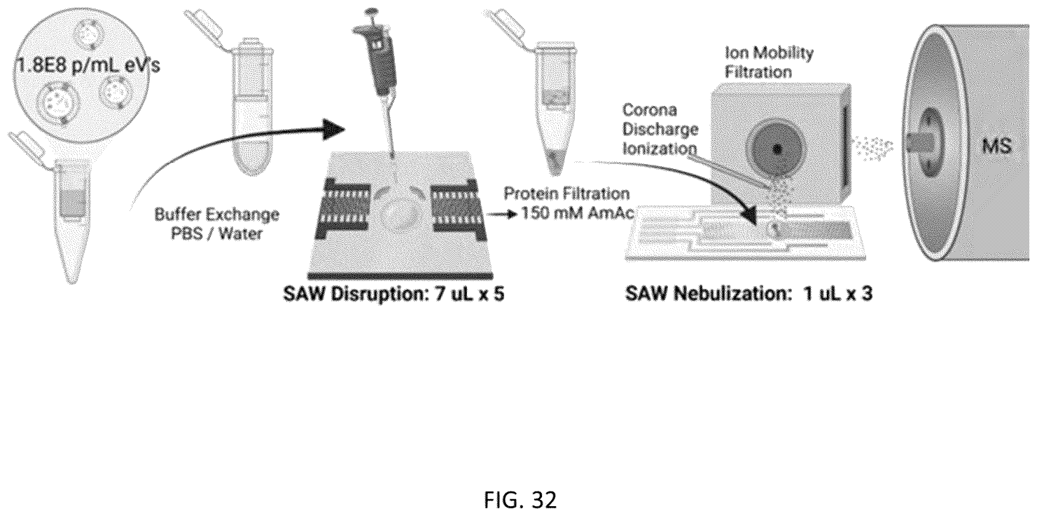

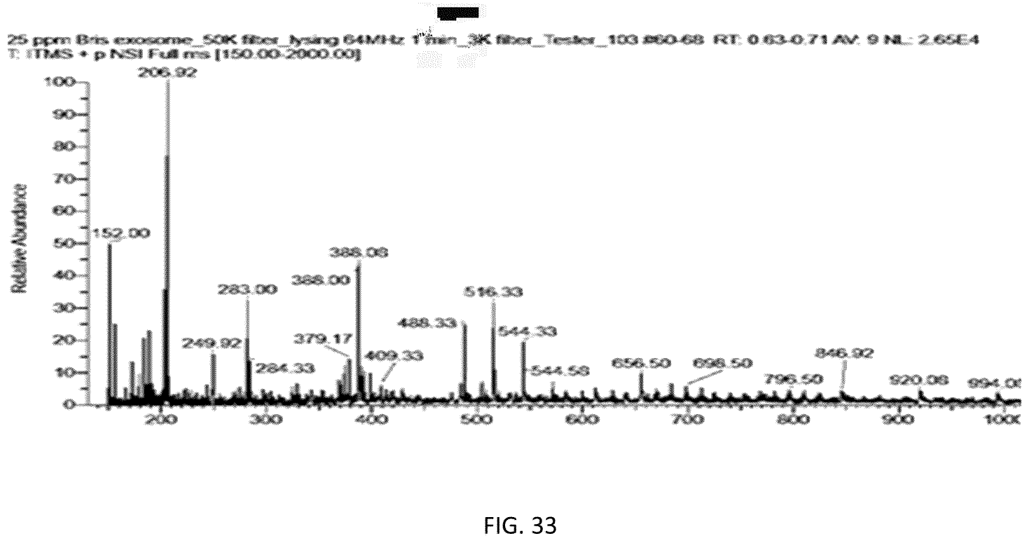

FIG. 32 shows a workflow using a first SAW device and a second SAW device to prepare extracellular vesicles (EVs) for mass spectrometry analysis. A 200 μL fraction of EVs was supplied. To prepare the EVs for the methods and systems disclosed herein, the EVs were buffer-exchanged into DI water and the sample subjected to disruptive conditions (SAWD mode) in 7-μL aliquots. With 30× dilution and ultrafiltration (3 kDa MWCO) to remove protein, the filtrate was rehydrated with ammonium acetate to facilitate ionization. Nebulizing SAW conditions were then applied for 3 replicates of 1-μL droplets on a linear ion trap MS. In FIG. 19A-19B, the composite mass spectra were processed using SkyLine software and screened against an open-source positive ion lipid library from others. Data were grouped into 9 lipid classes: phosphatidylcholines (PC), lysophosphatidylchlines (LPC), phosphoethanolamines (PE), lysophosphoethanolamines (LPE), cholesterylesters (CE), ceramides (Cer), sphingomyelins (SM), triacylglycerides (TAG), and diacylglycerides (DAG), constituting the prototype lipid panel. A mass spectrum from 3 nebulized 1-μL droplets is shown FIG. 33.

What is claimed is:

1. A method of preparing macromolecular structures for analysis, comprising:
placing a macromolecular sample on a surface acoustic wave (SAW) device comprising:
a piezoelectric surface,
a first transducer in contact with the piezoelectric surface,
a second transducer in contact with the piezoelectric surface, and
a sample region disposed between the first transducer and the second transducer and configured to receive the macromolecular sample,
the sample region configured to remain electrically isolated from each of the first transducer and the second transducer;
applying disruption electrical energy, comprising a disruption frequency and a disruption power, to each of the first transducer and the second transducer to transform the macromolecular sample into a disrupted macromolecular sample; and
applying nebulization electrical energy, comprising a nebulization frequency and a nebulization power, to each of the first transducer and the second transducer, to transform the disrupted macromolecular sample into a nebulized macromolecular sample.

2. The method of claim 1, wherein the disruption frequency is substantially equivalent to the nebulization frequency.

3. The method of claim 1, wherein the disruption power is different from the nebulization power.

4. The method of claim 1, wherein the disruption power is between 0.2 W and 1.5 W.

5. The method of claim 1, wherein the nebulization power is between 4 W and 15 W.

6. The method of claim 2, wherein each of the disruption frequency and the nebulization frequency is between 10 MHz and 100 MHz.

7. The method of claim 1, wherein at least one of the disruption electrical energy or the nebulization electrical energy is applied in a pulsed manner.

8. The method of claim 1, wherein the disruption electrical energy is applied for a disruption duration,
wherein the disruption duration is no less than 1 second and no greater than 120 seconds.

9. The method of claim 1, further comprising ionizing the nebulized macromolecular sample with a corona discharge device to produce an ionized macromolecular sample.

10. The method of claim 9, further comprising analyzing the ionized macromolecular sample with a mass spectrometer.

11. A method of preparing macromolecular structures for analysis, comprising:
providing a first surface acoustic wave (SAW) device comprising:
a first piezoelectric surface,
a first pair of transducers in contact with the first piezoelectric surface, and
a first sample region disposed between the first pair of transducers,
the first sample region configured to remain electrically isolated from each of the first pair of transducers;
placing a macromolecular sample on the first SAW device;
applying disruption electrical energy, comprising a disruption frequency and a disruption power, to each of the first pair of transducers to transform the macromolecular sample into a disrupted macromolecular sample; and
providing a second SAW device comprising:
a second piezoelectric surface,
a second pair of transducers in contact with the second piezoelectric surface,
a second sample region disposed between the second pair of transducers,
the second sample region configured to remain electrically isolated from each of the second pair of transducers; and
applying nebulization electrical energy, comprising a nebulization frequency and a nebulization power, to each of the second pair of transducers to transform the disrupted macromolecular sample into a nebulized macromolecular sample.

12. The method of claim 11, wherein the first SAW device is different than the second saw device; and
the method further comprising placing the disrupted macromolecular sample on the second SAW device prior to applying the nebulization electrical energy.

13. The method of claim 11, wherein the first SAW device is substantially equivalent to the second saw device.

14. The method of claim 11, further comprising ionizing the nebulized macromolecular sample with a corona discharge device to produce an ionized macromolecular sample.

15. The method of claim 14, further comprising analyzing the ionized macromolecular sample with a mass spectrometer.

16. A system for analyzing macromolecular structures, comprising:
a surface acoustic wave (SAW) device comprising:
a piezoelectric surface;
a first transducer in contact with the piezoelectric surface,
a second transducer in contact with the piezoelectric surface, and
a sample region configured to receive a macromolecular structure sample between, and electrically isolated from, each of the first transducer and the second transducer; and
a controller configured to apply electrical energy, having a frequency and a power, to the first transducer and second transducer.

17. The system of claim 16, wherein the frequency and the power are configured to nebulize a macromolecular sample, and
wherein the system further comprises an ionization source configured to ionize at least a portion of the nebulized macromolecular sample to produce an ionized macromolecular sample; and
wherein the system further comprises a mass spectrometer having an inlet configured to receive at least a portion of the ionized macromolecular sample.

18. The system of claim 17, wherein the ionization source is a corona discharge needle, configured to ionize at least a portion of the nebulized macromolecular sample to produce an ionized macromolecular sample.

19. The system of claim 18, further comprising high-field asymmetric waveform ion mobility spectrometry (FAIMS) configured to receive the ionized macromolecular sample.

20. The system of claim 16, further comprising a cooling apparatus in thermal contact with the surface acoustic wave (SAW) device.

21. The system of claim 16, wherein the first transducer and the second transducer are interdigital transducers.

22. The system of claim 16, wherein the first transducer and second transducer have a wavelength from 410 μm to 60 μm.

23. The system of claim 16, wherein the first transducer and second transducer have an aperture from 9.0 mm to 10 mm.

24. The system of claim 16, wherein the first transducer and second transducer each further comprise reflectors.

25. The system of claim 16, wherein the sample region is configured to receive a macromolecular structure sample having a volume from 0.25 μL to 1.5 μL.

26. The system of claim 16, wherein the sample region is configured to receive a continuous flow of a macromolecular structure sample.

27. The system of claim 26, wherein the continuous flow of a macromolecular structure sample comprises a flow rate, and
wherein the flow rate is 0.25 μL/min to 1.5 μL/min.

28. The system of claim 16, further comprising:
a second surface acoustic wave (SAW) device comprising:
a second piezoelectric surface;
a primary transducer in contact with the second piezoelectric surface,
an auxiliary transducer in contact with the second piezoelectric surface, and
a second sample region configured to receive a macromolecular structure sample between, and electrically isolated from, each of the primary transducer and the auxiliary transducer;
wherein the controller is configured to apply a second electrical energy, having a second frequency and a second power, to the primary transducer and auxiliary transducer; and
wherein the power and the second power are different powers.
